(19) United States
(12) Patent Application Publication
(10) Pub. No.: US 2012/0136082 A1
(43) Pub. Date: May 31, 2012

(54) BINDING AGENTS BASED ON HIGHLY BRANCHED POLYOLEFINS COMPRISING SILANE GROUPS

(75) Inventor: Juergen Oliver Daiss, Muenchen (DE)

(73) Assignee: WACKER CHEMIE AG, Muenchen (DE)

(21) Appl. No.: 13/389,027

(22) PCT Filed: Aug. 2, 2010
(86) PCT No.: PCT/EP2010/061196

§ 371 Date: Feb. 6, 2012

(30) Foreign Application Priority Data
Aug. 7, 2009 (DE) 10 2009 028 353.6

(51) Int. Cl. C09J 123/26; C09D 123/26; C08F 230/08; C08F 110/02; C08F 8/42

(52) U.S. Cl. 521/143; 525/288; 526/279; 524/535

(57) ABSTRACT

The invention relates to highly branched polymers (P) comprising at least one silane group, wherein at least one silicon atom carries a hydrolysable group of the general formula (I): R^{A}[(CH₂)(CHR^{a})]ₚ₋ₕ[(CH₂)ₖ(CR^{c}R^{d})]_{m-g}R^{u}qR^{o}ₜ[(CH₂)ₗ(CR^{-f}R^{si})]_{g+h}R^{B}, where R^{A}, R^{B}, R^{a}, R^{c}, R^{d}, R^{u}, R^{o}, R^{f}, R^{si}, g, h, k, l, m, p, q, t have the meanings indicated in claim 1, the relationship m−g=r×(ra+p+q+t) applies, and r has a value greater than or equal to 0.02; to a method for producing the polymers (P); to binding agents comprising at least one polymer (P); to the use of the polymers (P) according to claim 1 alone or as components of formulas as binding agents, as melting adhesives, as reactive melting adhesives, for producing adhesive points, glued structures, coatings, paints, adhesive tapes, adhesive films, or foams; to a method for cross-linking the polymers (P) or mixtures comprising at least one polymer (P) with water and cross-linked polymer (PV), obtainable by cross-linking with water or with oxidic groups or hydroxyl groups other than water or SiOH.

The present invention relates to polymers which contain silane group-containing highly branched polyolefins, the use thereof as binding agents, processes for the production and cross-linking of such polymers and the crosslinked polymers.

One embodiment of binding agents is for example melt adhesives. Melt adhesives can advantageously be processed without solvents, which minimizes industrial hygiene and emission problems. During the processing, the melt adhesive, which is solid at room temperature, is melted and applied to the adhesive joint. The strength of the adhesive is brought about by its solidification on cooling. The main component of such melt adhesives is a polymer, e.g. polyethylene, polypropylene, poly-α-olefin, polyvinyl acetate, ethylene-vinyl acetate copolymer or an ethylene-α-olefin copolymer. Owing to the nonpolar nature of the melt adhesives, good adhesion is achieved on nonpolar to polar substrates, such as for example polyolefins, PVC, polyvinyl acetate and polyesters. The melt adhesives exhibit thermoplastic behavior, i.e. the adhesive joint is thermally unstable and the adhesive action is lost at the melting point of the polymer at the latest. Typical limits for the heat resistance of adhesive joints which were created with various melt adhesives are to be found in ASTM D 4498-07.

In contrast to this, there are reactive melt adhesives which are crosslinkable after the creation of the adhesive bond. Such reactive melt adhesives can be prepared for example by grafting of polymers with silanes which bear at least one olefinic double bond and at least one hydrolyzable group on the silicon atom, so that a silane-crosslinking reactive melt adhesive is formed. Vinyltrimethoxysilane, vinyltriethoxysilane or vinyltris(2-methoxyethoxy)silane are for example suitable. If an adhesive bond is created from a silane-crosslinking reactive melt adhesive with substrates which have oxide or hydroxylated surfaces, then bonds between substrate and reactive melt adhesive are formed via the oxide oxygen atoms or via the hydroxyl groups of the substrate surface(s) by condensation reactions with the silane groups in the melt adhesive (see Adhesion, 2007, Iss. 4, p. 20-21; Adhäsion, 2007, No. 4, p. 22-24). These melt adhesives are therefore suitable for the adhesive bonding of substrate combinations of substrates both with hydroxylated/oxide and also with nonpolar surfaces in a great variety of combinations.

The rapidly occurring initial adhesion and strength of the reactive melt adhesives after the creation of the adhesive bond, which essentially is caused by the physical solidification below the melting point, often enables assembly of adhesive composites without auxiliary agents. In the subsequent moisture crosslinking the melt adhesive builds up stronger adhesion, strength and heat resistance. Here the adhesion buildup can inter alia take place as described above by condensation of the silane groups in the adhesive with oxide or hydroxyl groups on substrate surfaces. The crosslinking under the action of moisture takes place through the formation of siloxane bonds (moisture crosslinking or curing), as a result of which a thermoset is formed and increased thermal stability is ensured. The crosslinked adhesive bond remains stable even at elevated temperature, i.e. at temperatures around the melting point and above the melting point of the corresponding uncrosslinked polymer. In the first step of the moisture crosslinking, in the hydrolysis step, some or all of the hydrolyzable groups on the silicon are partly or fully cleaved off, as a result of which the corresponding silanols are firstly formed. Hence good adhesion on a wide range of substrates (polar to nonpolar, inorganic-mineral or metallic to organic) and buildup of good heat resistance of the adhesive joint created (as far as possible under typical atmospheric ambient conditions, so that artificial moistening and/or heating of the adhesive joint during the aging can be omitted), and sufficiently high thermal stability of the reactive melt adhesive before the crosslinking are desirable for reliable processing as a hot melt.

Analogous considerations and processes to those described above for melt adhesives can be transferred to other binding agents based on silane group-containing polymers and vice versa. The difference between melt adhesives in particular and binding agents in general is that common binding agents do not necessarily have to be solid at room temperature (20° C.).

Considered in this way, the performance of such a binding agent should depend strongly on the nature or structure of the silane groups bound to the polymer and should be able to be decisively influenced by catalysts, whereby, depending on the choice of the silane groups and/or catalysts, surprising effects can arise.

Thus U.S. Pat. No. 3,075,948 describes poly-α-olefins, which were radically grafted with hydrolyzable vinyl-functionalized silanes. Good adhesion to glass and good heat resistance are mentioned. Use as reactive melt adhesives is not described.

EP 827 994 A1 describes reactive melt adhesives based on radically vinylalkoxysilane-grafted amorphous poly-α-olefins, specifically an ethene-propene-1-butene copolymer grafted with vinyltrimethoxysilane, and the subsequent crosslinking by atmospheric moisture of the structures glued therewith.

Systems similar to those in EP 827 994 B1 are described in DE 34 90 656, DE 33 90 464 T1, DE 40 00 695 C2, EP 1 303 569 B1, EP 1 508 579 A1, EP 803 530 B1, WO 9207009 A2 and DE 195 16 457 A1.

DE 34 90 656 C describes the adhesive power of vinylsilane-grafted polyethylene or ethylene-vinyl acetate copolymer (EVA), sometimes with addition of carboxylic acids. Similar vinyl-alkoxysilane-grafted polymers are described in DE 33 90 464 T1, wherein the silane-grafted polymer is compressed to form a composite sheet which is used for the creation of adhesive composites

DE 40 00 695 C2 describes vinylalkoxysilane-grafted, largely amorphous poly-α-olefins as melt adhesives; the same applies for WO 9207009 A2, where waxes are used as the graft basis instead of amorphous poly-α-olefins; EP 1 303 569 B1 describes alkoxysilane group-containing binding agents in general.

EP 252 372 B1 describes the radical addition of mercapto-functionalized silanes, for example HSCH₂Si(OMe)₃ or HSCH₂Si(Me)(OMe)₂, to the isopropenyl terminal groups of poly-isobutene. The products can for example be used as adhesive agents. However, such mercapto-functionalized silanes cause an intolerable odor problem. Hence these silanes are desirable neither during processing at the manufacturer or processor nor at the purchaser of the end product, which can still contain traces of unreacted mercapto-functionalized silane.

EP 1 508 579 A1 describes the storage stability and cross-linking capacity of alkoxysilane-grafted waxes in the presence of atmospheric moisture with versus without dibutyltin dilaurate as the solvent-free crosslinking catalyst.

DE 195 16 457 A1 describes vinylalkoxysilane-grafted ethylene-vinyl acetate copolymers and mixtures thereof with a second polymer which is grafted with an unsaturated carboxylic acid or an unsaturated carboxylic acid anhydride or derivatives thereof, where the latter polymer contains a crosslinking catalyst.

EP 1 892 253 A1 and WO 2007/008765 A2 describe silane-grafted amorphous α-olefin polymers or ethene-α-olefin copolymers and the use thereof inter alia as adhesive agents or in reactive melt adhesives.

DE 10 2008 002 163.6 describes binding agents based on α-silane group-containing polymers. Through the α-silane technology, even without catalyst or with tin-free catalysts a rapid cross-linking of the adhesive joint is achieved.

In Monatshefte für Chemie, 2003, 134, p. 1081-1092, the use of (methacryloyloxymethyl)silanes is proposed for grafting onto polyolefins or onto ethylene-vinyl acetate copolymers or onto ethylene-methacrylate copolymers respectively for the production of rapidly crosslinking adhesive agents. However no specific practical instruction is given as to how such an adhesive agent can be produced, processed and/or crosslinked.

The company Degussa or Evonik markets a silane-grafted amorphous poly-α-olefin (APAO) under the name Vestoplast® 206, see https://my.coatings-colorants.com/wps/PA_{—}1_{—}2_{—}2B1/showOutOfBandContentServlet?conten t=oobc://brochures/.%2Fpdfs%2Fresins%2Fvestoplast_product_range_{—}0407.pdf and https://my.coatings-colorants.com/wps/PA_{—}1_{—}2_{—}2B1/showOutOfBandContentServlet?conten t=oobc://brochures/.%2Fpdfs%2Fresins%2Fkeeping_together_{—}34_{—}09_{—}1 09_e_{—}0508.pdf.

For the silane-functionalized binding agents it is desirable that they are not only stable in the uncrosslinked state in the melt at processing temperature, as a rule in the range 80-250° C., but also have as low as possible a viscosity, so that they can be processed easily. Since many substrates to be glued, such as for example polypropylene, are only temperature-stable to a limited extent inter alia because of their melting point, the binding agent must display a low viscosity in the lowest possible temperature ranges, in particular in the range up to 160° C. at most. Thus for the assessment of the suitability of a binding agent for use, not only the viscosity of the binding agent at any temperature but also the temperature dependence of its viscosity must be assessed. Admittedly the viscosity can be adjusted by additives, such as for example oils or waxes, however these additives influence other properties of the binding agent, such as for example its cohesion, often adversely. Thus the cohesion of the binding agent, measurable for example by its tensile tear strength, in the uncrosslinked and the crosslinked state should be as high as possible. For a measurement method for the determination of the tensile tear strength see the standard DIN EN ISO 527. If the cohesion of the binding agent is low, then on failure of the adhesive joint the binding agent tears within itself while some of the binding agent remains on each glued substrate surface. For an introduction to the assessment of fracture patterns of adhesive joints, see the standard DIN EN ISO 10365. On comparison of various binding agents, it is found that a high cohesion (tensile tear strength) of the binding agent is often associated with a high viscosity over broad temperature ranges, typically 100-190° C., in particular at low temperature, in particular in the range 120-160° C. Conversely, a low viscosity of the binding agent over broad temperature ranges, typically 100-190° C., in particular at low temperature, in particular in the range 120-160° C., is often associated with low cohesion.

There is a need for crosslinkable binding agents which display improved cohesive strength with at the same time the lowest possible viscosity, above all in the range 100-190° C., in particular in the range 120-160° C., with at the same time good adhesion to different types of substrate. (A measure of the cohesion of a binding agent here is for example its tensile tear strength (maximum tensile stress or tearing stress or both in the tensile tearing test), and a measure of the adhesion of a binding agent is for example the tensile shear strength of adhesive bonds created with the binding agent.) Further, the binding agents should crosslink as rapidly as possible under the mildest possible conditions, for example at room temperature under atmospheric humidity. If the binding agents release volatile organic cleavage products during the crosslinking (volatile organic chemicals=VOC), then these cleavage products should be of the lowest possible toxicity and the emission of such cleavage products should be as low as possible and decline rapidly. Thus in particular as volatile organic compounds isocyanates are harmful to health, and less harmful or harmless compounds, for example alcohols, would be more tolerable.

In the publication DE 827 994, it is stated that the improvement in the cohesion is achievable by crosslinking of alkoxy-silane groups which is obtained by grafting of an alkoxysilane with an unsaturated organofunctionalized group onto an amorphous poly-α-olefin; the corresponding grafted products are then used as binding agents or as binding agent components for the production of adhesive bonds which can be crosslinked subsequently and for example display improved heat resistance in the crosslinked state. On the basis of the technology disclosed in DE 827 994, it should thus be expected that the cohesive strength of the binding agent is decisively determined by the polymer used for the grafting only in the uncrosslinked state, before the moist crosslinking, while the cohesive strength in the crosslinked state, after the moist cross-linking, is quite decisively determined by the network which is created between the polymer molecules by the siloxane groups.

In the context of the present invention, it was established that the properties of the backbone of a polymer are decisively revealed not only in the uncrosslinked, but surprisingly also in the crosslinked state by properties such as for example high cohesive strength of a binding agent produced therefrom. Further, it was surprisingly established that highly branched or hyperbranched polyolefins (HBPO), in particular highly branched or hyperbranched polyethylenes (HBPE), are especially suitable for the production of silane group-containing polymers which combine the property of good cohesion (in the uncross-linked and in the crosslinked state) with the property of low viscosity at low temperature (in the uncrosslinked state) (in particular in the range 120-160° C.) not only through moist crosslinking of the silane groups, but also through especially suitable choice of the branched structure of the polymer backbone. The terms “backbone of a polymer” and “polymer backbone” and “highly branched or hyperbranched polyolefins (HBPO)” and “highly branched or hyperbranched polyethylenes (HBPE)”, like the polymers (P) presented below, are defined below.

The subject of the invention is polymers (P) which contain at least one silane group, wherein at least one silicon atom bears a hydrolyzable group, of the general formula I,

R^{A}[(CH₂)(CHR^{a})]ₚ₋ₕ[(CH₂)ₖ(CR^{c}R^{d})]_{m-g}R^{U}_{q}R^{O}ₜ[(CH₂)ₗ(CR^{f}R^{Si})]_{g+h}R^{B} (I),

wherein R^{A} and R^{B} are monovalent terminal groups,
R^{a} stands for hydrogen or for a hydrocarbon residue,
R^{c} and R^{d} stand for hydrogen or for hydrocarbon residues,
R^{U} stands for an unsaturated di- or trivalent hydrocarbon residue,
R^{O} stands for groups —CH₂—C(H)(OH)—, —CH₂—C(H)(OOH)—, —CH₂—C(═O)—, —C(H)(OH)—, —C(H)(OOH)— or —C(═O)—, the structure of the groups [(CH₂)ₖ(CR^{c}R^{d})] is not identical with the structure of the groups [(CH₂)(CHR^{a})], monomers of the structure H₂C═C(H) (R^{a}) were used for the production of the polymer (P) in at least one synthesis step, monomers of the structure H₂C═C(R^{c})(R^{d}) were used for the production of the polymers (P) in no synthesis step, the structure of the monomers H₂C═C(H) (R^{a}) is not identical with the structure of the monomers H₂C═C(R^{c})(R^{d}),
g can take integer values greater than or equal to 0,
h can take integer values greater than or equal to 0,
k can take the values 0 or 1,
l can take the values 0 or 1,
m can take integer values greater than or equal to 1,
p can take integer values greater than or equal to 9,
q can take integer values greater than or equal to 0,
t can take integer values greater than or equal to 0,
the sum of g+h takes a value greater than or equal to 1,
the sum of q+p+m+t takes an integer value greater than or equal to 10,
the difference m−g takes a value greater than or equal to 1,
the difference p−h takes a value greater than or equal to 5,
the relationship m−g=r×(m+p+q+t) applies,
r takes a value greater than or equal to 0.02,
R^{f} stands for hydrogen or for a hydrocarbon residue or for a residue R^{Si},
R^{Si} means a silicon-atom-containing group, wherein at least 50 mol. % of all R^{Si} mean a group [—(R²ᵥ—C¹(R³₂))_{w}—R⁴ₓ—SiXₛR¹₃₋ₛ], wherein
R¹ stands for a hydrocarbon residue or for a hydroxyl group or an Si₁-Si₂₀ siloxy residue or a condensed silane hydrolyzate of silanes with 1, 2, 3 or 4 hydrolyzable groups, which can be substituted with Si-bonded groups X, with Si-bonded hydroxyl groups or with C₁-C₂₀ hydrocarbon groups or with groups —C²R³₃,

or takes the structure —C²R³₃,
R² stands for a bond or for a C₁-C₂₀ hydrocarbon residue, which can be substituted by one or more monovalent substituents Q¹ or interrupted by one or more divalent groups Q² or interrupted by one or more trivalent groups Q³, wherein, when v is not equal to 0, that atom in R² which is bound to the carbon atom C¹ is a carbon atom,
R³ hydrogen or a C₁-C₁₈ alkyl or C₆-C₁₀ aryl residue which is unsubstituted or substituted by one or more monovalent substituents Q¹ or interrupted by one or more divalent groups Q² or interrupted by one or more trivalent groups Q³, wherein that atom in R³ which is bound to the carbon atom C¹ or C² is a carbon atom or a hydrogen atom,
R⁴ stands for a divalent siloxane group from a hydrolyzate of silanes with 1, 2, 3 or 4 hydrolyzable groups, which can be substituted with Si-bonded groups X, with Si-bonded hydroxyl groups or with C₁-C₂₀ hydrocarbon groups or with groups —C²R³₃, wherein, when x is not equal to 0, that atom in R⁴ which is bound to the unit SiX_{S}R¹₃₋ₛ is an oxygen atom, and that atom in R⁴ which is bound to the unit —(R²ᵥ—C¹(R³₂))_{w}— is a silicon atom,
Q¹ a hetero atom-containing monovalent residue selected from fluorine, chlorine, bromine, iodine, cyanato, isocyanato, cyano, nitro, nitrato, nitrito, silyl, silylalkyl, silylaryl, siloxy, siloxanoxy, siloxyalkyl, siloxanoxy-alkyl, siloxyaryl, siloxanoxyaryl, hydroxy, alkoxy, aryloxy, acyloxy, S-sulfonato, O-sulfonato, sulfato, S-sulfinato, O-sulfinato, amino, alkylamino, arylamino, dialkylamino, diarylamino, arylalkylamino, acylamino, imido, sulfonamido, mercapto, alkylthio or arylthio substituents, O-alkyl-N-carbamato, O-aryl-N-carbamato, N alkyl-O-carbamato, N-aryl-O-carbamato, optionally alkyl or aryl-substituted P-phosphonato, optionally alkyl or aryl-substituted O-phosphonato, optionally alkyl or aryl-substituted P-phosphinato, optionally alkyl or aryl-substituted O-phosphinato, optionally alkyl or aryl-substituted phosphino, hydroxycarbonyl, alkoxycarbonyl, aryloxycarbonyl, cyclic or acyclic carbonate, alkylcarbonato- or arylcarbonato substituents,
Q² a hetero atom-containing divalent residue selected from —O—, —S—, —N(R¹¹)—, —C(O)—, —C(O)—O—, —O—C(O)—O—, epoxy, —O—C(O)—N(R¹¹)—, —N(R¹¹)—C(O)—O—, —S(O)—, —S(O)₂—, —S(O)—O—, —S(O)₂—O—, —O—S(O)₂—O—, —C(O)—N(R¹¹)—, —S(O)₂—N(R¹¹)—, —S(O)₂—N[C(O)R¹³]—, —O—S(O)₂—N(R¹¹)—, —N(R¹¹)—S(O)₂—O—, —P(O)(OR¹²)—O—, —O—P(O)(OR¹²)—, —O—P(O)(OR¹²)—O—, —P(O)(OR¹²)—N(R¹¹)—, —N(R¹¹)—P(O)(OR¹²)—, —O—P(O)(OR¹²)—N(R¹¹)—, —N(R¹¹)—P(O)(OR¹²)—O—, —N[C(O)R¹³]—, —N═C(R¹³)—O—, —C(═NR¹¹)—, —C(R¹³)═N—O—, —C(O)—N[C(O)R¹³]—, —N[S(O)₂R¹⁴]—, —C(O)—N[S(O)₂R¹⁴]—, —N[P(O)R¹⁵₂]—, —Si(R¹⁶₂)—, —[Si(R¹⁶₂)O]ₐ—, —[OSi(R¹⁶₂]ₐ] or —[OSi(R¹⁶₂)]ₐO—, wherein R¹¹, R¹² and R¹³ stand for hydrogen or optionally substituted C₁-C₂₀ alkyl or C₆-C₂₀ aryl residues, R¹⁴ stands for an optionally substituted C₁-C₂₀ alkyl or C₆-C₂₀ aryl residue, R¹⁵ stands for an optionally substituted C₁-C₂₀ alkyl, C₆-C₂₀ aryl, C₁-C₂₀ alkoxy or C₆-C₂₀ aryloxy residue, R¹⁶ stands for a C₁-C₂₀ alkyl, C₆-C₂₀ aryl, C₁-C₂₀ alkoxy or C₆-C₂₀ aryloxy residue and a stands for a number from 1 to 100,
Q³ stands for a hetero atom-containing trivalent residue, selected from —N═ or —P═,
X means a hydrolyzable group,
s the values 1, 2 or 3,
v the values 0 or 1,
w the values 0 or 1, and
x the values 0 or 1.

The polymers (P) are highly branched or hyperbranched polyolefins, the structure whereof is not determined by the structure of the monomers of the structure CH₂═CHR^{a} used in the course of their production. This can be established from the structural units [(CH₂)(CHR^{a})] and [(CH₂)ₖ(CR^{c}R^{d})] in the general formula I: for the production of the polymer (P) monomers of the structure CH₂═CHR^{a} were used in at least one synthesis step. Through simple polyaddition of these monomers, the structural units [(CH₂)(CHR^{a})] represented in the general formula I, but not the structural units [(CH₂)ₖ(CR^{c}R^{d})], are obtained. The structural units [(CH₂)ₖ(CR^{c}R^{d})] are so-called branchings or branching sites and are formed by side reactions which can take place in the course of the polymerization or copolymerization of the monomers CH₂═CHR^{a}, by reactions which effect a constitutional isomerization. Such side reactions can for example be metal-catalyzed “chain walking isomerization” reactions or radical transfer reactions and are described in more detail below. In the sense of the present invention, the structural units [(CH₂)(CHR^{a})] are not designated as branchings or branching sites, since their structure is determined by the structure of the monomers CH₂═CHR^{a} used.

The silane group-containing highly branched or hyperbranched polyolefins (P) likewise display excellent adhesion to a great variety of substrates, whether polar or nonpolar. If the polymers (P) are used as binding agents or as a component of binding agents, then the binding agents display an improved cohesive strength with at the same time low viscosity, above all as regards the viscosity in the range 100-190° C., in particular in the range 120-160° C., with at the same time good adhesion to different types of substrate, where the cohesion of the binding agent is measureable by its tensile tear strength (maximum tensile stress or tear stress in the tensile tear test) and the adhesion of a binding agent inter alia by the tensile shear strength of adhesive bonds created with the binding agent. The binding agents crosslink rapidly under mild conditions, for example at room temperature under atmospheric humidity. If the binding agents release volatile organic cleavage products (volatile organic compounds=VOC) in the course of the crosslinking, these cleavage products in particular in the case of a moist crosslinking are preferably alcohols, if the groups X were selected from alkoxy groups, and thus these alcoholic cleavage products of the polymers (P) are markedly less harmful to health than the isocyanates which are emitted from conventional polyurethane-based binding agents.

The groups [(CH₂)ₖ(CR^{c}R^{d})], R^{U}, R^{O}, [(CH₂)ₗ(CR^{f}R^{Si})] and [(CH₂)(CHR^{a})] can for example be randomly distributed in the general formula I, or they can for example occur as blocks or in alternation.

The variable r is designated as the degree of branching of the polymer (P). The variable r takes values of at least 0.02, preferably of at least 0.04 and in particular of at least 0.06. The polymer (P) has on average at least 20, preferably at least 40 and particularly preferably at least 60 branchings per 1000 polymerized olefin monomers, where the term branching is defined as above. The degree of branching per 1000 polymerized olefin monomers for a polymer (P) of the general formula I equals r×1000. The degree of branching can also be stated in branchings per 1000 C atoms. Thus for example in the case of for example highly branched polyethylene (monomer: ethene, C2) a degree of branching of r=0.02, i.e. 20 branchings per 1000 polymerized monomers, corresponds to a degree of branching of 10 branchings per 1000 C atoms. Preferably the branchings, represented by structural units of the formula [(CH₂)ₖ(CR^{c}R^{d})], contain 2-100 C atoms, in particular 2-20 C atoms, when k=0, or 3-100 C atoms, in particular 3-20 C atoms, when k=1.

### Methods for the Determination of the Degree of Branching are Described in the Examples Section.

R^{A} and R^{B} are monovalent groups such as for example hydrogen, chlorine, hydroxy, hydroperoxy, alkylperoxy, arylperoxy, C₁ to C₁₀ alkoxy groups, for example methoxy, ethoxy, iso-propoxy, tert-butoxy, tert-pentoxy, phenyl, benzoyl, lauroyl, benzoyloxy, lauroyloxy, C₁ to C₁₀ alkyl groups, such as methyl, ethyl, propyl, iso-propyl, n-butyl, iso-butyl, sec-butyl, tert-butyl or vinyl groups, CH═CHR^{a} or CH═CR^{d}R^{d}.

R^{U} preferably stands for di- or trivalent unsaturated C₂ to C₁₀ hydrocarbon residues, such as for example residues equal to or containing —CH═CH—, —CH═CR^{a}—, —C(═CH₂)—, —C(═CHR^{a})—, ═C═CH—, ═C═CR^{a}—, —C≡C—, —CH(CH═CH₂)—, —CH(C≡CH)—, —CH(CH═CHCH₃)—, —CH(C≡CCH₃)—, —CH(CH₂CH═CH₂)—, —CH(CH₂CCH)—, —CH(CH₂CH₂CH═CH₂)—, —CH(CH₂CH═CHCH₃)— or —CH(CH═CH₂CH₂CH₃)—. For example cis and trans double bonds, triple bonds, cumulated and conjugated double bonds can occur in R^{U}.

If R^{a} stands for a hydrocarbon residue, then this can be saturated or unsaturated, aliphatic, aromatic or olefinic, cyclic or acyclic and preferably contains 1 to 10, in particular at most 6 carbon atoms. Preferred residues R^{a} are hydrogen, methyl, ethyl, n-butyl, n-hexyl and phenyl, in particular hydrogen. If R^{a} is selected equal to hydrogen, then the backbone of the polymer (P) is the residue of a highly branched polyethylene. For the production of the polymer (P) one or several different monomers of the structure H₂C═CHR^{a} can be used independently of each other in one or more synthesis steps. Accordingly, the polymer (P) can have independently of each other one or several different residues R^{a}.

Preferred residues R^{c} and R^{d} are hydrogen or linear or branched, saturated or unsaturated C₁-C₁₀₀, as a rule C₁-C₃₀, preferably C₁-C₂₀, in particular C₁-C₁₀ hydrocarbon residues, such as C₁, C₂, C₃, C₄, C₅, C₆, C₇, C₈, C₉, C₂₀, C₂₂, C₂₂, C₁₃, C₁₄, C₁₅, C₁₆, C₁₇, C₁₈, C₁₉, C₂₀ or C₂₁-C₃₀ hydrocarbon residues. Preferably R^{c} and R^{d} are of a length such that they could not in themselves already be described as polymers. One, two or more selected chain lengths or branchings, for example C₁, C₂, C₃, C₄, C₅, C₆ or C₇ or longer, can occur repeatedly.

Examples of hydrocarbon residues are methyl, ethyl, n-propyl, iso-propyl, n-butyl, iso-butyl, sec-butyl, tert-butyl, n-pentyl, sec-pentyl (1-methylbutyl or 1-ethylpropyl), iso-pentyl (2-methylbutyl or 3-methylbutyl), tert-pentyl, neo-pentyl, n-hexyl, 1-methylpentyl, 2-methylpentyl, 3-methylpentyl, 4-methylpentyl, 1-ethylbutyl, 2-ethylbutyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethyl-1-methylpropyl, 1-ethyl-2-methylpropyl, vinyl, 1-methylvinyl and 2-methylvinyl.

The sum of q+p+m+t is preferably at least 20, in particular at least 30 and preferably at most 20000, in particular at most 10000.

R^{f} preferably takes the same meanings as stated above as preferred for R^{a}. R^{f} particularly preferably means hydrogen.

In the present text, the terms “backbone of a/the polymer (P)” or “polymer backbone of a/the polymer (P)” are used, where the term backbone herein is defined such that the backbone of the polymer (P) follows from the polymer (P) by removal of the residues R^{f} and R.
(R²ᵥ—C(R³₂))_{w}—R⁴ₓ— is the linker of a hydrolyzable silane group SiX_{S}R¹₃₋ₛ to the backbone of the polymer (P).

If w=x=0 is selected, then the linker is a bond.

In order to ensure especially successful use, the polymer (P) preferably does not exceed certain degrees of crystallinity, determined by Xray diffraction or by enthalpy of fusion. The polymer (P) preferably has a degree of crystallinity, determined by Xray diffraction or enthalpy of fusion, of at most 65%; in particular the degree of crystallinity of the polymer (P) is at most 50%, particularly preferably at most 35%. The crystallinity of a polymer can be calculated from its heat of fusion determinable for example by “differential scanning calorimetry” (DSC), by dividing the standardized heat of fusion of the polymer tested by the standardized reference heat of fusion of the corresponding crystalline polymer. Thus the standardized reference heat of fusion of linear crystalline polyethylene is 280.5 J/g (Polymer Handbook, Fourth Edition, Volume 1, p. V/13; Editors: J. Brandrup, E. H. Immmergut, E. A. Grulke; Wiley Interscience, 1999, Hoboken, N.J., USA, ISBN 0-471-48171-8); this value is used as the reference heat of fusion for the calculation of the crystallinity of other polyethylenes on the basis of their heat of fusion.

The polymer (P) preferably displays defined melting ranges, determined by the measurement of the endotherm of melting by DSC (“differential scanning calorimetry”), wherein the peak of the endotherm of melting lies below 150° C., preferably below 130° C., in particular below 110° C., and wherein the higher temperature end of the endotherm of melting lies below 160° C., preferably below 140° C., in particular below 120° C. If several endothermy of melting for different crystalline regions are present, then the highest temperature endotherm of melting should be considered here.

If the polymer (P) is to be used as a melt adhesive or as a component in melt adhesive preparations, then the polymer (P) preferably displays defined melting ranges, determined by the measurement of the endotherm of melting by DSC (“differential scanning calorimetry”), wherein the peak of the endotherm of melting lies over 30° C., preferably over 40° C., in particular over 50° C., and wherein the higher temperature end of the endotherm of melting lies over 40° C., preferably over 50° C., in particular over 60° C. If several endothermy of melting for different crystalline regions are present, then the highest temperature endotherm of melting should be considered here.

The melting range of the polymers (P) is adjustable for example through their molecular weight, their degree of silane functionalization and above all through their degree of branching (see F. J. Balta Calleja, A. Schoenfeld, “Melting point and structure of polyethylene of low degree of polymerization”, Faserforschung and Textiltechnik 1967, Vol. 18, No. 4, p. 170-174). Thus for example very highly branched polyethylenes can be liquid down to room temperature, see P. Cotts, Z. Guan, E. Kaler, C. Co, “Structure of Highly Branched Polyethylenes Obtained with a Chain-Walking Catalyst”, American Physical Society, Annual March Meeting, Mar. 20-24, 2000, Minneapolis, Minn., Abstract #I22.012. The same relationships between degree of branching or molecular weight and melting range as described in these references for non-silane-functionalized polyolefins tend also to apply for the silane-functionalized polymers (P).

The molecular weight distributions of the polymers (P) can be unimodal, bimodal or multimodal and the polydispersity M_{w}/Mₙ is preferably at least 1 and preferably at most 200, particularly preferably at most 100, in particular at most 40.

Preferably the polymer (P) has a viscosity, measured at 150° C., of less than 200 Pa·s, in particular less than 50 Pa·s.

Preferably the polymer (P) has a viscosity, measured at 190° C., of less than 100 Pa·s, in particular less than 25 Pa·s.

The polymers (P) preferably have a number average molecular weight Mₙ of at least 2000, in particular at least 3000 g/mol and at most 50000, in particular at most 20000 g/mol. The polymers (P) preferably have a weight average molecular weight M_{w} of at least 3000, in particular at least 5000 g/mol and at most 500000, in particular at most 200000 g/mol. The number average and weight average molecular weights Mₙ and M_{w} are determined by gel permeation chromatography (GPC).

The polymers (P) can for example be modified by degradation, for example by thermolysis or by radical visbreaking reactions, by radical crosslinking reactions, by the action of electro-magnetic radiation or by hydrolysis or condensation reactions under the action of moisture. These modifications can for example take place during the radical conditions of the production process of the polymers (P), such as are described below, or can take place in a separate step, and they can take place in an atmosphere with optionally controlled oxygen concentration, whereby oxidation reactions can take place which can lead to the formation of optionally additional groups R^{O}. In order to ensure the processability of the polymers (P), these modifications should preferably not lead to a gelled product, i.e. not be taken so far that the gel point of the polymer (P) is reached or exceeded. The polymers (P) preferably display a gel content of 0% to 5%, in particular 0% to 2%, determined by extraction in stabilizer-containing boiling xylene as described in DIN EN 579. The standard DIN EN 579 relates to gel content determination for pipes of crosslinked polyethylene, and the method described is transferable to the polymers (P) and to binding agents produced therefrom.

The polymer (P) can be saturated or unsaturated or multiply unsaturated and the unsaturated groups can lie along the backbone, in the branches or at the ends of the backbone or of the branches. The polymer (P) is preferably a silane-functionalized highly branched or hyperbranched polyethylene, i.e. in this case R^{a} stands for hydrogen; a highly branched or hyperbranched polyethylene is abbreviated as HBPE.

If the residue Q¹ contains one or more silicon atoms, then these can preferably be substituted with alkoxy groups (in particular methoxy or ethoxy), alkyl groups (in particular methyl or ethyl) or with aryl groups (in particular phenyl). Preferred substituents Q¹ are chlorine, bromine, cyano, silyl, silylalkyl, silylaryl, siloxy, siloxanoxy, siloxyalkyl, siloxanoxyalkyl, siloxyaryl, siloxanoxyaryl, hydroxy, alkoxy, aryloxy, acyloxy, amino, alkylamino, arylamino, dialkylamino, diarylamino, arylalkylamino, acylamino, imido, sulfonamido, O-alkyl-N-carbamato, O-aryl-N-carbamato, N-alkyl-O-carbamato, N-aryl-O-carbamato, alkoxycarbonyl, aryloxycarbonyl, cyclic or acyclic carbonate, alkylcarbonato or arylcarbonato substituents, in particular chlorine, silyl, siloxy, alkoxy, aryloxy, acyloxy, acylamino, O-alkyl-N-carbamato, O-aryl-N-carbamato, N-alkyl-O-carbamato, N-aryl-O-carbamato, alkoxy-carbonyl or aryloxycarbonyl substituents.

Preferred substituents Q² are —O—, —N(R¹¹)—, —C(O)—, —C(O)—O—, —O—C(O)—O—, epoxy, —O—C(O)—N(R¹¹)—, —N(R¹¹)—C(O)—O—, —S(O)₂—O—, —O—S(O)₂—O—, —C(O)—N(R¹¹)—, —S(O)₂—N(R¹¹)—, —S(O)₂—N[C(O)R¹³]—, —O—S(O)₂—N(R¹¹)—, —N(R¹¹)—S(O)₂—O—, —N[C(O)R¹³]—, —N═C(R¹³)—O—, —C(═NR¹¹)—, —C(R¹³)═N—O—, —C(O)—N[C(O)R¹³]—, —N[S(O)₂R¹⁴]—, —C(O)—N[S(O)₂R¹⁴]—, —Si(R¹⁶₂)—, —[Si(R¹⁶₂)O]ₐ—, —[OSi(R¹⁶₂)]ₐ—, —[OSi(R¹⁶₂)]ₐO—, in particular —O—, —C(O)—, —C(O)—O—, —O—C(O)—N(R¹¹)—, —N(R¹¹)—C(O)—O—, —C(O)—N(R¹¹)—, —N[C(O)R¹³]—, —Si (R¹⁶₂)—, —[Si (R¹⁶₂)O]ₐ— or —[OSi(R¹⁶₂)]ₐ—.

R¹ is preferably an unsubstituted C₁-C₆ alkyl or phenyl residue, in particular methyl or ethyl residue.

R² is preferably a C₁-C₂₀ hydrocarbon group which contains only carbon and hydrogen atoms, in particular a group selected from —CH₂— or —CH₂CH₂—.

R³ is preferably hydrogen or an unsubstituted C₁-C₁₈ alkyl or C₆-C₁₀ aryl residue, in particular hydrogen or a methyl, ethyl or phenyl residue.

R⁴ is preferably a divalent siloxane group from a hydrolyzate of silanes with 1, 2, 3 or 4 hydrolyzable groups, which can be substituted with Si-bonded groups X or with C₁-C₂₀ hydrocarbon groups which contain only carbon and hydrogen atoms.

The groups —(R²ᵥ—C¹(R³₂))_{w}— preferably stand for unsubstituted hydrocarbon residues with 1-20 C atoms or for a bond (i.e. in the latter case w takes the value 0). Preferred groups —(R²ᵥ—C¹(R³₂))_{w}— contain alkyl residues with 1, 2, 3, 4, 5 or 6 C atoms. Particularly preferred are groups —(R²ᵥ—C¹(R³₂))_{w}— which stand for structures selected from —(CH₂)_{α}— or —(CH₂)_{β}—CH(CH₃)—(CH₂)_{γ}— or for a bond, wherein α means an integer from 2 to 20, preferably 2 or 3, β an integer from 0 to 20, preferably 0 or 1, in particular 0, and γ an integer from 0 to 20, preferably 0 or 1, in particular 0 and wherein the combinations of β=0 and γ=0 to 10 (in particular β=0 and γ=0, 1 or 2) or β=1 and γ=0 are preferred.

The term “hydrolyzable group X” means that bonds of the type Si—X, optionally under the auxiliary action of a catalyst, can be cleaved by water, wherein as a rule a molecule HX and a group Si—OH is formed, which can optionally enter into subsequent reactions, such as for example condensation reactions. Preferred residues X are alkoxy, alkenoxy, amino, hydrocarbon-amino, acylamino, propen-2-oxy, amino, C₁-C₁₀ alkylamino, C₆-C₂₀ arylamino, alkylamino, di-C₆-C₂₀ arylamino and C₆-C₂₀ aryl-C₁-C₁₀ alkylamino, in particular C₁-C₆ alkoxy, such as methoxy, ethoxy, n-propoxy, iso-propoxy, n-butoxy, iso-butoxy, sec-butoxy, tert-butoxy, n-pentoxy, iso-pentoxy, sec-pentoxy, tert-pentoxy or n-hexoxy.

s preferably means the values 2 or 3.

v preferably means the value 1.

x preferably means the value 0.

The residues R^{Si}, which mean a silicon atom-containing group, but are not a [—(R²ᵥ—C¹(R³₂))_{w}—R⁴ₓ—SiXₛR¹₃₋ₛ] group, preferably mean groups of the general formula II

[—R⁵_{δ}—R⁶_{ε}—SiX_{φ}R⁷_{3-φ}] (II)

wherein
R⁵ stands for a bond or for a C₁-C₂₀ hydrocarbon residue, which can be substituted by one or more monovalent substituents Q¹ or interrupted by one or more divalent groups Q² or interrupted by one or more trivalent groups Q³, wherein, when δ is not equal to 0, that atom in R⁵ which is bound to the unit —R⁶_{ε}—SiX_{φ}R⁷_{3-φ} is a carbon atom,
R⁶ stands for a divalent siloxane group from a hydrolyzate of silanes with 1, 2, 3 or 4 hydrolyzable groups, which can be substituted with Si-bonded groups X or with Si-bonded groups R⁸, wherein, when ε is not equal to 0, that atom in R⁶ which is bound to the unit SiX_{φ}R⁷_{3-φ} is an oxygen atom, and that atom in R⁶ which is bound to the unit —R⁵_{δ}— is a silicon atom,
R⁷ stands for a group R⁸ or for an Si₁-Si₂₀ siloxy residue or condensed silane hydrolyzate from silanes with 1, 2, 3 or 4 hydrolyzable groups, which can be substituted with Si-bonded groups X or with Si-bonded groups R⁸,
R⁸ means a C₁-C₂₀ hydrocarbon residue which is unsubstituted or substituted by one or more monovalent substituents Q¹ or interrupted by one or more divalent groups Q² or interrupted by one or more trivalent groups Q³ or a hydroxyl group,
δ means the values 0 or 1,
ε means the values 0 or 1,
φ means a value selected from 0, 1, 2 or 3 and
X can take the meanings defined above.

R⁵ is preferably a C₁-C₂₀ hydrocarbon group which contains only carbon and hydrogen atoms, in particular a group selected from —CH₂CH₂—, —CH(CH₃)—, —CH₂CH₂CH₂—, —CH(CH₃)CH₂— or —CH₂CH(CH₃)—.

R⁶ is preferably a divalent siloxane group from a hydrolyzate of silanes with 1, 2, 3 or 4 hydrolyzable groups, which can be substituted with Si-bonded groups X or with C₁-C₂₀ hydrocarbon groups which contain only carbon and hydrogen atoms.

R⁷ preferably stands for a group R⁸.

R⁸ is preferably a C₁-C₂₀ hydrocarbon residue, which contains only carbon and hydrogen atoms, in particular methyl, ethyl or phenyl.

Preferably at least 80 mol. %, particularly preferably at least 95 mol. %, in particular 99 mol. % to 100 mol. % of all residues R^{Si} mean a [—(R²ᵥ—C¹(R³₂))_{w}—R⁴ₓ—SiXₛR¹₃₋ₛ] group. In an especially preferred embodiment all residues R^{Si} in the polymer (P) are [—(R²ᵥ—C¹(R³₂))_{w}—R⁴ₓ—SiXₛR¹₃₋ₛ] groups.

The sum of g+h preferably stands for integers selected from 1, 2, 3, 4, 5 or 6 to 100, in particular for integers selected from 1, 2, 3, 4, 5 or 6 to 20.

Based on any desired sample of the polymer (P), the ratio n(Σg+Σh): n(P), i.e. the ratio of the sum of all g+h, summed over all molecules of the polymer (P) of the sample, to the number of the molecules of the polymer (P) in the sample is preferably at least 0.01, in particular at least 0.1 and preferably at most 50, in particular at most 20. The ratio n(Σg+Σh): n(P) can be determined for example by determining the molar concentration c(Σg+Σh) of structural elements of the general formula I per gram polymer (P) (unit [mol/g]). This determination can for example be determined by nuclear magnetic resonance, by atomic absorption spectroscopy (“AAS”; element to be quantified: Si), by measurement of the optical emission in the inductively coupled plasma (“inductively coupled plasma—optical emission spectroscopy”, “ICP-OES”; element to be quantified: Si), by infrared spectroscopy (band to be integrated e.g. Si—OMe), by measurement of the number of releasable groups HX by hydrolysis or by incineration (calculation of the Si mass as SiO₂ in the ash). The following then applies:

n(Σg+Σh):n(P)=c(Σg+Σh)×Mₙ(P),

wherein Mₙ(P) is the number average molecular weight of the polymer (P). Mₙ(P) can for example be determined by gel permeation chromatography. After measurement of Mn(P) and of c(Σg+Σh), the ratio n(Σg+Σh): n(P) can be calculated from the measured values.

The polymers (P) can for example be produced by radical grafting.

A further subject of the invention is a process for the production of the polymers (P), wherein at least one highly branched or hyperbranched polyolefin HBPO, in particular at least one highly branched or hyperbranched polyethylene HBPE is grafted under radical conditions with one or more unsaturated compounds, at least one whereof is a silane or a silane precondensate, which (i) contains at least one unsaturated group sufficiently enabling for grafting and which (ii) bears at least one hydrolyzable group on at least one silicon atom.

On the basis of their English designation, “highly branched polyolefins” or “hyperbranched polyolefins” are designated as HBPO. On the basis of its English designation “highly branched polyethylene” or “hyperbranched polyethylene” is designated as HBPE.

Polyolefins can be produced by polymerizing olefins for example with radical, anionic, cationic or metal catalysis in the sense of scheme 1:

nCH₂═CHR^{a}-->R^{A}[(CH₂)(CHR^{a})]ₙR^{B} Scheme 1

wherein R^{A} and R^{B} are the terminal groups designated above, and n as a rule means an integer greater than 10.

The terminal groups R^{A} and R^{B} for example result from the start and the stoppage of the polymerization reaction by means of which the polyolefin was produced. Here, the structure of the structural units [(CH₂)(CHR^{a})] is determined by the structure of the CH₂═CHR^{a} monomers used and follow from these by polymerization and formation of two single bonds from each double bond.

Highly branched or hyperbranched polyolefins HBPO, especially highly branched or hyperbranched polyethylenes HBPE, are also produced from olefins of the structure CH₂═CHR^{a} and without use of olefins of the structure CH₂═CR^{c}R^{d}, however they have structural units [(CH₂)ₖ(CR^{c}R^{d})], which are not identical with the structure of the groups [(CH₂)(CHR^{a})], wherein the structure of the monomers H₂C═CHR^{a} is not identical with the structure of the monomers H₂C═CR^{c}R^{d}. The structural units [(CH₂)ₖ(CR^{c}R^{d})] here are the branching sites of the polymer; their structure is not determined by the structure of the monomers CH₂═CHR^{a} used. By simple polyaddition of these monomers, the structural units [(CH₂)(CHR^{a})] represented in the formula III defined below, but not the structural units [(CH₂)ₖ(CR^{c}R^{d})], are obtained. The structural units [(CH₂)ₖ(CR^{c}R^{d})] are so-called branchings or branching sites and are formed by side reactions which can take place in the course of the polymerization or copolymerization of the monomers CH₂═CHR^{a}, by reactions which effect a constitutional isomerization. Such side reactions can for example be metal-catalyzed “chain walking isomerization” reactions or radical transfer reactions and are described in more detail below. R^{a}, R^{c}, R^{d} and k have the above meanings.

Highly branched or hyperbranched polyolefins HBPO, especially highly branched or hyperbranched polyethylenes HBPE, can also, for example due to the production process, contain unsaturated hydrocarbon groups R^{U}, and, for example due to the action of oxidizing agents such as (atmospheric) oxygen, oxygen-containing groups R^{O}, which have the above meanings.

The structure of highly branched or hyperbranched polyolefins HBPO, produced from one or more olefins of the structure CH₂═CHR^{a}, especially highly branched or hyperbranched polyethylenes HBPE, which corresponds to a highly branched or hyperbranched polyolefin HBPO with the selection R^{a} equals hydrogen, is represented by the general formula III,

R^{A}[(CH₂)(CHR^{a})]ₚ[(CH₂)ₖ(CR^{c}R^{d})]ₘR^{U}_{q}R^{O}ₜR^{B} (III)

wherein R^{A}, R^{B}, R^{a}, R^{c}, R^{d}, R^{U}, R^{O}, p, k, m, q and t have the above meanings, the structure of the groups [(CH₂)ₖ(CR^{c}R^{d})] is not identical with the structure of the groups [(CH₂)(CHR^{a})], monomers of the structure H₂C═C(H) (R^{a}) were used for the production of the polymers of the formula III in at least one synthesis step,
monomers of the structure H₂C═C(R^{c})(R^{d}) were used for the production of the polymers of the formula III in no synthesis step,
the structure of the monomers H₂C═C(H) (R^{a}) is not identical with the structure of the monomers H₂C═C)(R^{c})(R^{d}),
the relationship m=r′×(m+p+q+t) applies and
r′ takes a value greater than or equal to 0.02.

Preferably highly branched or hyperbranched polyolefin HBPO of the general formula III is used in the process for the production of the polymers (P) by grafting.

R^{A}, R^{B}, R^{U}, R^{a}, R^{c}, R^{d}, k, m, p and q preferably take the same meanings as stated as preferred for these variables in the general formula I; examples of what meanings inter alia these variables can take are also presented there.

If R^{a} is selected equal to hydrogen, then the highly branched polyolefin of the formula III is a highly branched poly-ethylene. For the production of the highly branched polyolefin, one or several different monomers of the structure H₂C═CHR^{a} can be used independently of each other in one or more synthesis steps. Accordingly, the highly branched polyolefin can have independently of each other one or several different residues R^{a}.

The groups [(CH₂)ₖ(CR^{c}R^{d})], [(CH₂)(CHR^{a})], R^{U} and R^{O} in the formula III can for example occur randomly distributed, as blocks or in alternation.

Highly branched or hyperbranched polyolefins HBPO, especially highly branched or hyperbranched polyethylenes HBPE can be produced by adjusting the reaction conditions during the production process such that the polymerization reaction does not proceed exclusively according to scheme 1, but rather such that branchings are formed, for example by radical transfer reactions, when the polyolefin is produced under radical conditions, or by so-called “chain walking isomerization”, when the polyolefin is produced with metal catalysis.

“Chain walking isomerization” means isomerization by migration of the catalyst along the polyolefin forming from the olefinic monomers under the polyolefin production conditions, followed by catalysis of the buildup of a new branch starting from the site to which the catalyst has migrated, followed by renewed “chain walking isomerization” etc. The extent of the “chain walking isomerization” and hence the degree of branching of the resulting polyolefin can for example be controlled by the polyolefin pressure during the polymerization, see for example Zhibin Guan, P. M. Cotts, E. F. McCord, S. J. McLain, “Chain Walking: A New Strategy to Control Polymer Topology”, Science 1999, Vol. 283, p. 2059-2062.

Catalysts which are capable of the so-called “chain walking isomerization” are for example known under the name Versipol® (DuPont), and the accompanying production processes for the highly or hyperbranched polyolefins, especially for the highly branched or hyperbranched polyethylenes HBPE, have been disclosed by DuPont (see for example EP 946 609 A1, EP 1 068 245 A1, EP 1 127 897 A2 and EP 1 216 138 A1). Catalysts and production processes for the production of highly branched or hyperbranched polyolefins, especially of highly branched or hyperbranched polyethylenes HBPE, were further disclosed for example by BASF SE (see for example the patent specification DE 199 60 123 A1) and Basell Polyolefins GmbH (see for example EP 1 322 680 A1).

On the basis of the “chain walking isomerization”, a highly branched or hyperbranched polyolefin can be produced from ethene alone and is then designated as highly branched or hyperbranched polyethylene (HBPE). α-olefins with at least three or more C atoms, alone, as a mixture with each other or optionally in mixtures with ethene, can also be used for the production of highly branched or hyperbranched polyolefins (HBPO), wherein the catalyst can migrate along the alkyl chain of the α-olefin by the “chain walking” mechanism, which can lead to initially partially or wholly linearized incorporation of the α-olefin into the highly or hyperbranched polyolefin, during which branchings can form—also by “chain walking”—on the polyolefin irrespective of this. The resulting highly branched polyolefins HBPO and—as a special case—likewise the highly branched polyethylenes HBPE thus differ from poly-α-olefins in that the length and structure of the branch is not predetermined by the structure of the α-olefin used.

As highly branched or hyperbranched polyolefins HBPO, in particular highly branched or hyperbranched polyethylenes HBPE, which can be used for the production of the silane-functional-ized polymers (P) by grafting, certain selected polyethylene types of low density (“low density polyethylene”, LDPE) which were produced by radical high pressure polymerization of olefins, as a rule with ethene as the main component, can also be used. In the radical high pressure polymerization of ethene to LDPE intra- and intermolecular radical transfer reactions take place. Both can lead to the formation of branchings, so that branching sites, i.e. alkyl side chains of differing structure are formed. When the resulting LDPE is highly branched, it is designated as highly branched or hyperbranched polyethylene (HBPE). Corresponding products are for example obtainable from Westlake Chemical (Epolene C types, for example Epolene C-10, C-13 or C-15).

α-Olefins with at least three or more C atoms can also be used alone, as a mixture with each other or optionally in mixtures with ethene, for the production of highly branched or hyperbranched polyolefins (HBPO). With increasing content of α-olefins with at least three or more C atoms, under radical conditions low molecular weight products are increasingly obtained, which enables corresponding adjustment of the poly-olefin properties. The degree of branching of the polyolefin to be produced (and hence essential product properties such as for example hardness, crystallinity, melt viscosity, heat of fusion and melting point) is controllable by selection of the conditions in the radical polymerization, thus a lower pressure and/or a higher temperature leads to a higher degree of branching of the resulting polymer and vice versa (see DE 25 32 418 A1, GB 861 277 or DE 1 303 352 B). Further, the degree of branching of the resulting polymer can be influenced by addition of regulators or by selection of the radical initiator which is used for the polymerization: if different initiators are compared, then at comparable temperature under comparable polymerization conditions a lower initiator half life leads to a polymer with a lower degree of branching and vice versa (see DE 25 32 418 A1). The resulting highly branched polyolefins HBPO and—as a special case—likewise the highly branched polyethylenes HBPE thus differ from poly-α-olefins in that the length and structure of the branches is not predetermined by the structure of the α-olefin used.

Highly branched polyolefins HBPO or highly branched poly-ethylenes HBPE can have short- and long-chain branchings, optionally with repetitions of certain branch length ranges, and branches can also themselves again be branched. Highly branched or hyperbranched polyolefins HBPO which have long chain branchings (i.e. side chains with more than 6 carbon atoms) are also called “long chain branched polyolefins”, LBPO. Highly branched or hyperbranched polyethylenes HBPE which have long chain branchings (i.e. side chains with more than 6 carbon atoms) are also called “long chain branched polyethylenes”, LBPE.

Highly branched polyolefins HBPO or highly branched poly-ethylenes HBPE can also be produced by degradation of higher molecular weight polyolefins by exposing a higher molecular weight polyolefin to conditions (for example thermal stress, radical conditions, electromagnetic radiation) under which the polyolefin decomposes. These processes can be conducted in an atmosphere with optionally controlled oxygen partial pressure. In this case the corresponding oxidized polymers which have oxygen-containing groups, such as for example R^{O} groups, can be obtained.

The highly branched or hyperbranched polyolefins HBPO, in particular highly branched or hyperbranched polyethylenes HBPE which can be used for the production of the silane-functionalized polymers (P) by grafting, are structurally clearly to be distinguished from poly-α-olefins and from α-olefin copolymers, corresponding silane-functionalized derivatives whereof are already known. The structural differences manifest themselves as follows: if a catalyst for the polymerization or copolymerization of α-olefins for the production of poly-α-olefins or α-olefin copolymers (optionally also with ethene) which is not sufficiently capable of “chain walking isomeriz-ation” under the selected reaction conditions is used, or if the polymerization or copolymerization is performed under radical conditions which do not sufficiently allow the formation of branchings, and if during this for example propene is (co-)polymerized (for example under catalysis with a metallocene catalyst), then the resulting polymer contains methyl side chains; if but-1-ene is (co-) polymerized, then the resulting polymer contains ethyl side chains, etc. (i.e. pentene->propyl side chains, hex-1-ene->n-butyl side chains, 3-methylpent-1-ene->(2-methylpropyl) side chains, oct-1-ene->n-hexyl side chains etc.); products which are produced according to this technology and represent this product type include for example LLDPE and PE-LLD. “Not sufficiently” in this context is defined by the degree of branching of the resulting polyolefin of less than 20 branchings per 1000 polymerized olefin monomers, this would correspond to a value (not according to invention) for r of less than 0.02, or if ethene was used as the olefin monomer, less than 10 branchings per 1000 C atoms. In other words, if α-olefins of the structure H₂C═CH—R^{a} are for example (co)polymerized with catalysts which are not capable of “chain walking isomerization”, or if the polymerization or copolymer-ization is performed under radical conditions, which do not sufficiently allow the formation of branchings, the residues R^{a} are later found as side chains of the resulting poly-α-olefin or of the resulting α-olefin copolymer, and the branchings R^{c} and R^{d} would not in this case be found in sufficient number.

In the sense of the present invention, the sites in polyolefins which have the structure —CH₂—C(H) (R^{a})— are not regarded or designated as branching or disruption sites, since their structure is determined by the structure of the olefin monomers H₂C═CHR^{a} used.

If silane-functionalized highly branched or hyperbranched polyolefins HBPO, in particular silane-functionalized highly branched or hyperbranched polyethylenes HBPE, are compared with silane-functionalized poly-α-olefins or α-olefin copolymers which have each been provided with analogous silane functional-ities, then the structural differences of the polymers used for the silane functionalization are reflected in the polymer residues of the resulting silane-functionalized polymers, so that not only the polymers used for the silane functionalization, but also the resulting silane-functionalized polymers themselves markedly differ in structure.

Highly branched or hyperbranched polyolefins HBPO, in particular highly branched or hyperbranched polyethylenes HBPE which are suitable for the production of polymers (P) by grafting, display a degree of branching of 20 or more, preferably of 40 or more, in particular 60 or more branchings per 1000 polymerized olefin monomers, where the term branching is defined as above. The variable r′ is designated as the degree of branching of the highly branched or hyperbranched polyolefin of the formula III.

The variable r′ takes values of at least 0.02, preferably of at least 0.04, and in particular of at least 0.06. The degree of branching per 1000 polymerized olefin monomers for a polyolefin of the general formula III is equal to r′×1000. The degree of branching can also be stated in branchings per 1000 C atoms. Thus for example a degree of branching of r′=0.02, i.e. 20 branchings per 1000 polymerized monomers, for example in the case of highly branched polyethylene (monomer: ethene, C2) corresponds to a degree of branching of 10 branchings per 1000 C atoms. Preferably the branchings, represented by structural units of the formula [(CH₂)ₖ(CR^{c}R^{d})], contain 2-100 C atoms, in particular 2-20 C atoms, when k=0, or 3-100 C atoms, in particular 3-20 C atoms, when k=1.

### Methods for the Determination of the Degree of Branching are Described in the Examples Section.

In summary, both the long chain branchings and also the branched branches and also the structures of the branches which are not determined by the structure and number of the olefins used as monomers for the production, the highly branched or hyperbranched polyolefins HBPO, in particular the highly branched or hyperbranched polyethylenes HBPE, differ from conventional α-olefin homo- or copolymers.

Preferably, in the process for the production of the polymers (P) by grafting silanes selected from the general formula IV

R²¹₂C³═C⁴(R²²)—(R²³_{y}—C⁵(R²⁴₂))_{z}—R²⁵ᵤ—SiXₛR¹₃₋ₛ (IV),

are used, wherein R¹, X and s have the meanings stated above, R²¹ and R²² mean hydrogen, fluorine, chlorine or a hydrocarbon residue which is unsubstituted or substituted by one or more monovalent substituents Q¹ or interrupted by one or more divalent groups Q² or interrupted by one or more trivalent groups Q³,

R²³ can take the same meanings as defined above for R², wherein, when y is not equal to 0, that atom in R²³ which is bound to the carbon atom C⁵ is a carbon atom,

R²⁴ can take the same meanings as defined above for R³, wherein that atom in R²⁴ which is bound to the carbon atom C⁵ is a carbon atom or a hydrogen atom,

R²⁵ can take the same meanings as R⁴ as defined above, wherein, when u is not equal to 0, that atom in R²⁵ which is bound to the unit —SiXₛR¹₃₋ₛ is an oxygen atom, and that atom in R²⁵ which is bound to the unit R²¹₂C³=C⁴(R²²)—(R²³_{y}—C⁵(R²⁴₂))_{z}— is a silicon atom,

u can take the same meanings as defined above for x,

y can take the same meanings as defined above for v,

z can take the same meanings as defined above for w,

wherein R¹, R²¹, R²², R²³, R²⁴, R²⁵, X, Q¹, Q² and Q³ can be bound to each other within the general formula IV, so that one or more rings are formed,

and wherein z=1, when that atom in R²² which is bound to the carbon atom C⁴ in the general formula IV is an atom other than a carbon atom or a hydrogen atom.

The unsaturated group sufficiently enabling for grafting is represented in the general formula IV by the structural unit R²¹₂C═C(R²².) Preferably the unsaturated group sufficiently enabling for grafting in the silanes of the general formula IV is a terminal vinyl group of the structure H₂C═CH— or part of a bicyclo[2.2.1]heptene system and not part of an aromatic conjugated system.

Preferably u in the general formula IV takes the value 0, in particular when z takes the value 1.

Preferably y in the general formula IV takes the value 0.

Preferably z in the general formula IV takes the value 0, in particular when u takes the value 1.

Preferably R²¹ and R²² in the general formula IV take the meaning hydrogen.

The group (R²³_{y}—C(R²⁴₂))_{z}— is preferably an unsubstituted organic residue with 1-20 C atoms. Preferred groups —(R²³_{y}—C(R²⁴₂))_{z}— contain alkyl residues with 1, 2, 3, 4, 5 or 6 C atoms. Particularly preferred are groups (R²³_{y}—C(R²⁴₂))_{z}— with structures selected from —(CH₂)ᵢ—, wherein i is an integer from 1 to 20, preferably 1 to 14, in particular 1, 2, 3, 4, 5, 6, 7, 8, 9 or 10.

The preferred meanings of R¹ and X in the general formula IV are the same as defined above as preferred for R¹ and X in the general formula I.

Preferably the silanes of the general formula IV are selected from vinyltrialkoxysilanes, vinylmethyldialkoxysilanes, allyl-trialkoxysilanes or allylmethyldialkoxysilanes, wherein the alkoxy groups are selected from methoxy, ethoxy or (2-methoxy-ethoxy) groups and wherein different alkoxy groups can also be present mixed on one silicon atom. Particularly preferably, vinyltris(2-methoxyethoxy)silane, vinyltrimethoxysilane, vinyldimethoxyethoxysilane, vinylmethoxydiethoxysilane, vinyltriethoxysilane, vinylmethylbis(2-methoxyethoxy)silane, vinylmethyldimethoxysilane, vinylmethylmethoxyethoxysilane or vinylmethyldiethoxysilane are selected as silanes of the general formula IV.

In the process, a highly branched or hyperbranched polyolefin HBPO is used. The branches of HBPO can themselves again be branched. The branches can be short chain (C₁-C₆) or long chain (in this case greater than or equal to C₇, as a rule C₇-C₁₀₀, in particular C₇-C₃₀) or be both short and also long chain, wherein one, two or more selected chain lengths of the branchings, for example C₁, C₂, C₃, C₄, C₅, C₆ or C₇ or longer, can occur repeatedly. Preferably the branchings are of a length such that they would not already in themselves be described as polymers. HBPO can be saturated or unsaturated or multiply unsaturated and the unsaturated groups can lie along the backbone, in the branches or at the ends of the backbone or of the branches. Preferably a highly branched or hyperbranched polyethylene, abbreviated as HBPE, is used as the highly branched or hyperbranched polyolefin HBPO in the process. In the sense of the present invention, highly branched or hyperbranched poly-ethylenes HBPE (R^{a} equals hydrogen) are a subset of highly branched or hyperbranched polyolefins HBPO(R^{a} can be other than hydrogen), where the highly branched or hyperbranched polyethylenes HBPE are produced exclusively or mainly from ethene (R^{a} in the monomer used equals hydrogen) and the highly branched or hyperbranched polyolefins HBPO from any desired olefinically unsaturated olefin monomers (R^{a} in the monomers used can be other than hydrogen). The highly branched or hyperbranched polyethylene HBPE was mainly, i.e. preferably more than 80%, in particular more than 90% produced from ethene as the monomer; production exclusively from normal commercial ethene qualities or exclusively from technical, pure or high purity ethene or exclusively from ethene as the monomer is most particularly preferred.

The structural features of the polymer architectures of HBPO or of HBPE which are used in the process are correspondingly reflected in the backbone of the polymers (P) of the general formula I which are produced therefrom. During the process for the production of the polymers (P) both chain cleavage (visbreaking) and also combination of macroradicals of HBPO can occur as side reactions in the course of a desired radical grafting reaction. These side reactions can take place on the still ungrafted polyolefins—before the grafting to give polymers (P) of the general formula I—or on silane-functionalized polymers (P) increasingly present during the reaction. However these reactions in no way alter the fact that HBPO are essentially highly branched or hyperbranched polyolefins HBPO with the structural features described; the same applies for the corresponding polymer backbones in the polymers (P).

Preferably the highly branched or hyperbranched polyolefin HBPO used for the production of the polymers (P) by grafting has a viscosity, measured at 150° C., of less than 200 Pa·s, in particular less than 50 Pa·s. Preferably the highly branched or hyperbranched polyolefin HBPO used for the production of the polymers (P) has a viscosity, measured at 190° C., of less than 100 Pa·s, in particular less than 25 Pa·s.

The highly branched or hyperbranched polyolefin HBPO used for the production of the polymers (P) preferably has a number average molecular weight Mₙ of at least 2000, in particular at least 3000 g/mol and at most 50000, in particular at most 20000 g/mol. The polymers (P) preferably have a weight average molecular weight M_{w} of at least 3000, in particular at least 5000 g/mol and at most 500000, in particular at most 200000 g/mol.

Preferably the highly branched or hyperbranched polyolefin HBPO used for the production of the polymer (P) by grafting displays certain degrees of crystallinity, determined by X-ray diffraction or by enthalpy of fusion, namely preferably less than 65%, in particular less than 50%, particularly preferably less than 35%.

The highly branched or hyperbranched polyolefin HBPO used for the production of the polymer (P) by grafting preferably has defined melting ranges, determined by the measurement of the endotherm of melting by DSC (“differential scanning calorimetry”), wherein the peak of the endotherm of melting lies below 150° C., preferably below 130° C., in particular below 110° C., and wherein the higher temperature end of the endotherm of melting lies below 160° C., preferably below 140° C., in particular below 120° C. If several endotherms of melting for different crystalline regions are present, then the highest temperature endotherm of melting should be considered here.

If the polymer (P) to be produced is to be used as a melt adhesive or as a component in melt adhesive preparations, then the highly branched or hyperbranched polyolefin HBPO used for the production of the polymer (P) by grafting preferably has defined melting ranges, determined by the measurement of the endotherm of melting by DSC (“differential scanning calori-metry”), wherein the peak of the endotherm of melting lies over 30° C., preferably over 40° C., in particular over 50° C., and wherein the higher temperature end of the endotherm of melting lies over 40° C., preferably over 50° C., in particular over 60° C. If several endotherms of melting for different crystalline regions are present, then the highest temperature endotherm of melting should be considered here.

The melting range of highly branched or hyperbranched poly-olefins HBPO, in particular highly branched or hyperbranched polyethylenes HBPE, is adjustable for example through their molecular weight and above all through their degree of branching (see F. J. Balta Calleja, A. Schoenfeld, “Melting point and structure of polyethylenes of low degree of polymerization”, Faserforschung and Textiltechnik 1967, Vol. 18, No. 4, p. 170-174). Thus for example very highly branched polyethylenes can be liquid down to room temperature, see P. Cotts, Z. Guan, E. Kaler, C. Co, “Structure of Highly Branched Polyethylenes Obtained with a Chain-Walking Catalyst”, American Physical Society, Annual March Meeting, Mar. 20-24, 2000, Minneapolis, Minn., Abstract #122.012.

The molecular weight distribution of the highly branched or hyperbranched polyolefin HBPO used for the production of the polymers (P) by grafting can be unimodal, bimodal or multimodal and the polydispersity Mw/Mn can take values of 1 to 30, preferably of 1 to 10. Both Mw and also Mn and also the polydispersity Mw/Mn of the polymer (P) produced in the process can deviate from the corresponding values of the highly branched or hyperbranched polyolefins HBPO used. Thus under the radical conditions of the process Mw, Mn and the polydispersity Mw/Mn can increase by combination of macroradicals or decrease by breakage of macroradicals. Those skilled in the art can, by suitable preliminary experiments, easily determine for each polymer under consideration for use in the process whether a polymer under radical conditions tends rather to an increase or decrease in the aforesaid values, so that after implementation of the process polymers (P) with Mn, Mw and Mw/Mn values optionally deviating therefrom are obtained, where the latter should lie in the particular desired range. In general, the tendency to a decrease in Mn, Mw and Mw/Mn increases with increasing degree of branching and increasing content of residues R^{a} other than hydrogen in the highly branched or hyperbranched polyolefin HBPO used and vice versa.

The highly branched or hyperbranched polyolefin HBPO used in the process for the production of the polymer (P) by grafting, in particular the highly branched or hyperbranched polyethylene HBPE used, can be used as a mixture of two or more highly branched or hyperbranched polyolefins HBPO, in particular highly branched or hyperbranched polyethylene HBPE, and/or in mixtures or blends with one or more further components such as fillers or polymers, in particular with one or more further polymers, for example with a further polyolefin, for example polyethylenes such as HDPE or LDPE, a C₃-C₁₈ poly-α-olefin (e.g. polymers of propene, 1-butene or 2-methyl-1-propene) or a copolymer of the aforesaid polyolefins (e.g. ethene-α-olefin copolymer, in particular ethene-propene copolymer, ethene-1-butene copolymer, ethene-1-hexene copolymer and ethene-1-octene copolymer, ethene-propene-1-butene terpolymer, LLDPE); with rubbers; with polyvinyl acetate or ethene-vinyl acetate copolymer; with ethene-vinyl ether copolymer, for example ethene-ethyl vinyl ether, ethene-butyl vinyl ether or ethene-isobutyl vinyl ether copolymer; with polyolefin or poly-α-olefin homo- or copolymer waxes; with polyesters such as for example poly-1,4-butylene glycol or -1,2-ethylene glycol or -diethylene glycol terephthalate or phthalate or adipate; with polyamides (Nylon®- or Perlon® type); with acrylate polymers or acrylate copolymers, for example ethene-butyl acrylate copolymer, ethene-ethyl acrylate copolymer, ethene-methyl acrylate copolymer, ethene-acrylic acid copolymer, wherein the latter can also be partly or wholly present as a salt, for example as the zinc salt, poly(methyl acrylate), poly(ethyl acrylate), poly(butyl acrylate); a methacrylate polymer or methacrylate copolymer, for example ethene-butyl methacrylate copolymer, ethene-ethyl methacrylate copolymer, ethene-methyl methacrylate copolymer, ethene-methacrylic acid copolymer, wherein the latter can also be partly or wholly present as a salt, for example as the zinc salt, poly(methyl methacrylate), poly(ethyl methacrylate), poly(butyl methacrylate); with polyalkylene oxides such as polyethylene oxide or polypropylene oxide or with polyethers, for example from tetrahydrofuran; or with copolymers or block copolymers or graft copolymers of two or more of said polymers in all combinations.

The highly branched or hyperbranched polyolefin can be modified before, during or after the grafting process with the silane of the general formula IV by grafting with other olefinically unsaturated compounds or with further silanes which bear olefinically unsaturated groups.

The silanes of the general formula IV are grafted onto highly branched or hyperbranched polyolefins HBPO, preferably onto highly branched or hyperbranched polyethylenes HBPE, in a radical grafting reaction whereby silane group-containing polymers (P) are obtained. A mixture containing 100 parts by weight of highly branched or hyperbranched polyolefin HBPO, preferably at least 0.1, in particular at least 0.5, particularly preferably at least 1 part by weight and preferably at most 40, in particular at most 30, particularly preferably at most 20 parts by weight of silane and preferably at least 0.01, in particular at least 0.03 part by weight and preferably at most 5, in particular at most 1 part by weight of radical initiator which releases radicals under the selected reaction conditions, is preferably reacted for this. Preferably the molar ratio of silane of the general formula IV to initiator is at least 3:1, in particular at least 5:1 and preferably at most 2000:1, in particular at most 400:1.

The grafting is preferably performed at temperatures of at least 80° C., in particular at least 120° C. and preferably at most 350° C., in particular at most 300° C. The grafting can be performed at atmospheric pressure, increased pressure, under vacuum or under partial vacuum. The combination of pressure and temperature in the grafting is preferably selected such that the boiling point of the silane used at the selected pressure is greater than the selected temperature, or that the silane used at the selected pressure has a boiling point of greater than 20° C., preferably of greater than 40° C., so that during the grafting the silane can be kept under reflux with common cooling media such as water or brine cooling, or that at the selected pressure and the selected temperature, part or preferably more than half of the quantity of the silane used dissolves in the grafting base. The grafting is preferably performed at or above atmospheric pressure—as a rule at least 900 hPa absolute—and particularly preferably at atmospheric pressure, preferably at 900-1100 hPa absolute. The grafting is preferably performed in an inert atmosphere, for example argon or nitrogen, with low oxygen and water content or in the absence of oxygen and/or water, preferably with a water and oxygen concentration each of less than 1000 ppm, in particular each of less than 200 ppm. As radical initiators, for example dialkyl peroxides, such as for example di-tert-butyl peroxide, 2,5-dimethyl-2,5-di-(tert-butylperoxy)hexane, dicumyl peroxide, tert-butyl-α-cumyl peroxide, α,α′-bis(tert-butylperoxy)-diisopropylbenzene, di-tert-amyl peroxide or 2,5-dimethyl-2,5-di-(tert-butylperoxy)hex-3-yne, for example diacyl peroxides such as for example dibenzoyl peroxide, dilauroyl peroxide, didecanoyl peroxide or diisononanoyl peroxide, for example alkyl peresters such as for example 3-hydroxy-1,1-dimethylbutyl peroxyneodecanoate, α-cumyl peroxyneodecanoate, 2-hydroxy-1,1-dimethylbutyl peroxyneoheptanoate, α-cumyl peroxyneoheptanoate, tert-amyl peroxyneodecanoate, tert-butyl peroxyneodecanoate, tert-butyl peroxyneoheptanoate, tert-amyl peroxypivalate, tert-butyl peroxypivalate, 3-hydroxy-1,1-dimethylbutyl peroxy-2-ethylhexanoate, 2,5-dimethyl-2,5-di(2-ethylhexanoylperoxy)-hexane, tert-amyl peroxy-2-ethylhexanoate, tert-butyl peroxy-2-ethylhexanoate, tert-butyl peroxyisobutyrate, 2,5-dimethyl-2,5-di(benzoylperoxy)hexane, tert-amyl peroxyacetate, tert-amyl peroxybenzoate, tert-butyl peroxyisononanoate, tert-butyl peroxyacetate, tert-butyl peroxybenzoate, di-(tert-butylperoxy) phthalate and tert-butyl peroxy-2-ethylhexanoate, for example perketals such as for example 1,1-di(tert-butylperoxy)-3,3,5-trimethylcyclohexane, 1,1-di(tert-butylperoxy)cyclohexane, 1,1-di-(tert-amylperoxy)cyclohexane, 2,2-di-(tert-butylperoxy)-butane, 2,2-di-(tert-amylperoxy)propane, n-butyl-4,4-di-(tert-butyl)peroxy valerate, ethyl-3,3-di-(tert-amylperoxy)butyrate or ethyl-3,3-di-(tert-butylperoxy)butyrate, for example cyclic peroxides such as for example 3, 6,9-triethyl-3,6,9-trimethyl-1,1,4,4,7,7-hexaoxacyclononane, for example azo compounds such as for example α,α′-azobis-isobutyronitrile or for example C radical forming agents such as for example 3,4-dimethyl-3,4-di-phenylhexane, 1,2-diphenylethane or 2,3-dimethyl-2,3-diphenyl-butane, peroxycarbonates or -dicarbonates such as for example di(2-ethylhexyl) peroxydicarbonate, di-n-propyl peroxy-dicarbonate, di-sec-butyl peroxydicarbonate, photoinitiators such as for example 2-hydroxy-2-methyl-1-phenyl-1-propanone, or chlorine, bromine or iodine in combination with the action of electromagnetic radiation are used in the process. Further examples of useful chemical radical initiators are for example described in D. Munteanu, in Plastics Additives Handbook, 5th Edition, Hanser-Verlag, Munich 2001, p. 741-742, or in the brochure “Initiators for high polymers” from Akzo Nobel (Issue: June 2006; Code: 2161 BTB Communication, © 2006 Akzo Nobel Polymer Chemicals, see http://www.akzonobel-polymerchemicals.com/NR/rdonlyres/C2D64A96-B539-4769-A688-2447258D3DCA/0/InitiatorsforHighPolymersAkzoNobe12006.pdf). Further, the radical initiator can be introduced into the reaction as a component of the polymer to be grafted. For this, the polymer to be grafted can for example be exposed to electromagnetic radiation, such as for example light, ultraviolet radiation or gamma radiation, for example in the presence of oxygen (O₂). Here for example polymer-bound hydroperoxide groups are formed, which can act as radical initiators when the polymer is used later in the grafting process.

The grafting can for example be performed in the solid substance, for example by allowing the radical initiator and the silane to diffuse into the solid highly branched or hyperbranched polyolefin HBPO and then heating the mixture to a temperature below the melting point of the mixture. The grafting can also be performed in the melt, for example by mixing the radical initiator and the silane into the highly branched or hyperbranched polyolefin HBPO in the solid or liquid state, melting if this has not yet occurred, and heating the melt. The grafting can for example be performed in solution, suspension, emulsion or solvent-free. The grafting can for example be performed as a batch process (for example in kettle reactors, preferably stirred), or for example continuously (for example in extruders, in dynamic mixers or in static mixers, optionally with one or more downstream, optionally temperature-controlled retention vessels or retention pipes), or for example in cascade reactions. If the process is performed in batch reactions, then preferably one lot after another is run in the batch reactor, as far as possible without thoroughly cleaning the reactor between emptying and the next subsequent lot.

With implementation in the extruder, at least one silane as defined above and at least one radical initiator are fed into the highly branched or hyperbranched polyolefin HBPO or to a mixture which contains at least one highly branched or hyper-branched polyolefin at a suitably temperature-controlled point in the extruder. Suitably temperature-controlled here means that the point of input is temperature-controlled so that the temperature is low enough to prevent hazardous decomposition of the chemicals introduced and of the polymer, but at the same time high enough to process the polymer in the extruder (the corresponding upper and lower temperature limits can easily be determined by those skilled in the art from tables for the temperature dependence above all of the half life of the selected radical initiator and from the substance data as regards viscosity and melting point of the highly branched or hyperbranched polyolefin used; these tables or substance data can for example be obtained from the respective manufacturers). The introduction of silane and radical initiator can take place separately from one another or in the form of a mixture of both, during which in both cases further additives can be mixed in. If a mixture is fed in, then the maximum temperature at the point of introduction is preferably based on the decomposition temperature of the mixture. The addition is controlled such that on contact of the silane with the highly branched or hyperbranched polyolefin HBPO the radical initiator has not yet or not yet fully reacted. Optionally, further radical initiator and/or further silane can be fed in later or added at other locations on the extruder. The retention time of the reaction mixture, consisting of silane, radical initiator and polymer, in the extruder is preferably at least 0.1, in particular at least 0.5 minutes and preferably at most 30 minutes, in particular at most 10 minutes. Preferably, the combination of initiator, temperature and retention time is selected such that the retention time corresponds to 2-10 half lives of the initiator under the given temperature regime. The retention time can for example be varied through the length of the extruder, the revolution rate, the screw pitch or by the use of recirculation elements or baffle plates. The retention time can for example be determined by addition of a colorant, for example graphite, in the input region of the extruder and determination of the time until the coloration appears at the exit. For reactive extrusion, a single-screw extruder or a co- or contrarotating twin-screw extruder can for example be used.

In batch grafting, a mixture containing one or more highly branched or hyperbranched polyolefins HBPO (grafting base), at least one radical initiator and at least one silane as defined above is heated to a temperature at which the radical initiator forms radicals, over a period of preferably 2-10 half lives of the radical initiator used at the selected temperature. The silane and the initiator can be fed in as a mixture or separately from one another each in one or in several addition steps.

Before or during the grafting, one or more crosslinking catalysts can already be mixed in, irrespective of whether the grafting is performed as a batch reaction or continuously. Also, the grafting can take place without added crosslinking catalyst and catalysts can be added later. Optionally, it is also possible to add no crosslinking catalyst.

In a first preferred embodiment of the grafting by reactive extrusion, the highly branched or hyperbranched polyolefin HBPO is processed as melt in an extruder and a mixture of silane and initiator introduced in a zone along the extruder screw of the extruder. In a second preferred embodiment, the silane and the initiator are introduced separately from each other along the extruder screw of the extruder. In a third preferred embodiment, the silane is introduced into the intake of the extruder together with the grafting base HBPO and the initiator is introduced along the extrusion zone. In a fourth preferred embodiment, the initiator is introduced into the intake of the extruder together with the grafting base HBPO and the silane is introduced along the extrusion zone. In a fifth preferred embodiment, silane and initiator are fed into the intake of the extruder together with the grafting base HBPO. The temperature profile of the extruder is preferably selected such that the temperature after the initiator input zone is equal to or higher than, in particular higher than in the initiator input zone itself in at least one region following the input zone. The initiator is preferably introduced at a point which is temperature-controlled such that the half life of the initiator at this temperature is at least 1 second, in particular at least 10 seconds.

In a first preferred embodiment of the grafting in at least one dynamic or static mixer, the melted highly branched or hyper-branched polyolefin HBPO is conveyed in a dynamic or static mixer as a melt; an extruder can for example be used for this. Further, the silane and the radical initiator are fed into the mixer separately from one another or as a mixture. If a dynamic mixer is used, then preferably at least one retention vessel or pipe which is temperature-controlled above the decomposition temperature of the selected radical initiator and can contain the optional further mixing components is attached to this mixer. The temperature-controlled retention vessel or the temperature-controlled retention pipe is preferably sized relative to the selected throughput such that the mixture is retained in the temperature-controlled reaction zone over a period of preferably 2-10 half lives of the radical initiator used. The temperature control is preferably effected by thermal insulation. In a second preferred embodiment, the silane is fed into the inlet of the extruder together with the grafting base HBPO or along the extrusion zones and the initiator is fed into the dynamic or static mixer; the preferred structure of all further components corresponds to the design as described in the first preferred embodiment. In a third preferred embodiment, the silane and the radical initiator are fed separately from one another or as a mixture into the intake of the extruder together with the grafting base HBPO or fed in along the extrusion zones and further initiator is optionally fed into the dynamic or static mixer; the preferred structure of all further components corresponds to the design as described in the first preferred embodiment. In all embodi-ments, the initiator is preferably fed in at a point which is temperature-controlled such that the half life of the initiator at this temperature is at least 1 second, in particular at least 10 seconds. Several dynamic mixers and/or static mixers and/or retention pipes can be connected in series.

The combination of temperature in the grafting and initiator is preferably selected such that the initiator displays a half life of preferably at least 0.01 seconds, in particular at least 0.1 seconds, and of preferably at most one hour, in particular at most 0.1 hours.

The polymers (P) can for example be produced by radical copolymerization of olefins with silanes which have olefinic-ally unsaturated groups.

A further subject of the invention is a process for the production of the polymers (P), wherein at least one olefinic-ally unsaturated monomer of the structure H₂C═CHR^{a} is copolymerized under radical conditions with at least one compound which has (i) at least one olefinically unsaturated C═C double bond and (ii) at least one silicon atom which bears at least one hydrolyzable group, and wherein the polymers (P) display a degree of branching of r greater than or equal to 0.02, where r is as defined above in the general formula I, and wherein the copolymerization is performed at temperatures of 150° C. to 360° C. and at pressures of 5 MPa to 500 MPa absolute.

As compounds which fulfill the requirements (i) and (ii), silanes or silane precondensates can be used in this process. Preferably silanes selected from the general formula V

H₂C═C(R^{f})(R^{Si}) (V),

wherein R^{f} and R^{Si} take the meanings defined above, are used in this process.

The unsaturated group is represented in the general formula V by the structural unit H₂C═C. In the silanes of the general formula V, the unsaturated group is preferably part of a terminal vinyl group of the structure H₂C═CH— and not part of an aromatic conjugated system.

The preferred meanings of R^{f} and R^{Si} in the general formula V are the same as defined above as preferred for R^{f} and R^{Si} in the general formula I.

Preferably the silanes of the general formula V are selected from vinyltrialkoxysilanes, vinylmethyldialkoxysilanes, (vinylalkyl)trialkoxysilanes, (vinylalkyl)(methyl)dialkoxy-silanes, allyltrialkoxysilanes or allylmethyldialkoxysilanes, wherein the alkoxy groups are selected from methoxy, ethoxy- or (2-methoxyethoxy) groups and wherein different alkoxy groups can also be present mixed on one silicon atom. Particularly preferably, vinyltris(2-methoxyethoxy)silane, vinyltri-methoxysilane, vinyldimethoxyethoxysilane, vinylmethoxy-diethoxysilane, vinyltriethoxysilane, vinylmethylbis(2-methoxyethoxy)silane, vinylmethyldimethoxysilane, vinylmethyl-methoxyethoxysilane, vinylmethyldiethoxysilane, allyltris(2-methoxyethoxy)silane, allyltrimethoxysilane, allyldimethoxy-ethoxysilane, allylmethoxydiethoxysilane, allyltriethoxysilane, allylmethylbis(2-methoxyethoxy)silane, allylmethyldimethoxy-silane, allylmethylmethoxyethoxysilane, allylmethyldiethoxy-silane, but-3-enyltris(2-methoxyethoxy)silane, but-3-enyltri-methoxysilane, but-3-enyldimethoxyethoxysilane, but-3-enyl-methoxydiethoxysilane, but-3-enyltriethoxysilane, but-3-enyl-methylbis(2-methoxyethoxy)silane, but-3-enylmethyldimethoxy-silane, but-3-enylmethylmethoxyethoxysilane, but-3-enylmethyl-diethoxysilane, pent-4-enyltris(2-methoxyethoxy)silane, pent-4-enyltrimethoxysilane, pent-4-enyldimethoxyethoxysilane, pent-4-enylmethoxydiethoxysilane, pent-4-enyltriethoxysilane, pent-4-enylmethylbis(2-methoxyethoxy)silane, pent-4-enylmethyl-dimethoxysilane, pent-4-enylmethylmethoxyethoxysilane, pent-4-enylmethyldiethoxysilane, hex-5-enyltris(2-methoxyethoxy)-silane, hex-5-enyltrimethoxysilane, hex-5-enyldimethoxyethoxy-silane, hex-5-enylmethoxydiethoxysilane, hex-5-enyltriethoxy-silane, hex-5-enylmethylbis(2-methoxyethoxy)silane, hex-5-enyl-methyldimethoxysilane, hex-5-enylmethylmethoxyethoxysilane, hex-5-enylmethyldiethoxysilane, hept-6-enyltris(2-methoxy-ethoxy)silane, kept-6-enyltrimethoxysilane, hept-6-enyl-dimethoxyethoxysilane, hept-6-enylmethoxydiethoxysilane, hept-6-enyltriethoxysilane, hept-6-enylmethylbis(2-methoxyethoxy)-silane, hept-6-enylmethyldimethoxysilane, hept-6-enylmethyl-methoxyethoxysilane, kept-6-enylmethyldiethoxysilane, oct-7-enyltris(2-methoxyethoxy)silane, oct-7-enyltrimethoxysilane, oct-7-enyldimethoxyethoxysilane, oct-7-enylmethoxydiethoxy-silane, oct-7-enyltriethoxysilane, oct-7-enylmethylbis(2-methoxyethoxy)silane, oct-7-enylmethyldimethoxysilane, oct-7-enylmethylmethoxyethoxysilane, oct-7-enylmethyldiethoxysilane, dec-9-enyltris(2-methoxyethoxy)silane, dec-9-enyltrimethoxy-silane, dec-9-enyldimethoxyethoxysilane, dec-9-enylmethoxy-diethoxysilane, dec-9-enyltriethoxysilane, dec-9-enylmethyl-bis(2-methoxyethoxy)silane, dec-9-enylmethyldimethoxysilane, dec-9-enylmethylmethoxyethoxysilane, dec-9-enylmethyldiethoxy-silane, dodec-11-enyltris(2-methoxyethoxy)silane, dodec-11-enyltrimethoxysilane, dodec-11-enyldimethoxyethoxysilane, dodec-11-enylmethoxydiethoxysilane, dodec-11-enyltriethoxy-silane, dodec-11-enylmethylbis(2-methoxyethoxy)silane, dodec-11-enylmethyldimethoxysilane, dodec-11-enylmethylmethoxy-ethoxysilane, dodec-11-enylmethyldiethoxysilane, tetradec-13-enyltris(2-methoxyethoxy)silane, tetradec-13-enyltrimethoxy-silane, tetradec-13-enyldimethoxyethoxysilane, tetradec-13-enylmethoxydiethoxysilane, tetradec-13-enyltriethoxysilane, tetradec-13-enylmethylbis(2-methoxyethoxy)silane, tetradec-13-enylmethyldimethoxysilane, tetradec-13-enylmethylmethoxyethoxy-silane, tetradec-13-enylmethyldiethoxysilane, hexadec-15-enyl-tris(2-methoxyethoxy)silane, hexadec-15-enyltrimethoxysilane, hexadec-15-enyldimethoxyethoxysilane, hexadec-15-enylmethoxy-diethoxysilane, hexadec-15-enyltriethoxysilane, hexadec-15-enylmethylbis(2-methoxyethoxy)silane, hexadec-15-enylmethyl-dimethoxysilane, hexadec-15-enylmethylmethoxyethoxysilane, hexadec-15-enylmethyldiethoxysilane, octadec-17-enyltris(2-methoxyethoxy)silane, octadec-17-enyltrimethoxysilane, octadec-17-enyldimethoxyethoxysilane, octadec-17-enylmethoxydiethoxy-silane, octadec-17-enyltriethoxysilane, octadec-17-enylmethyl-bis(2-methoxyethoxy)silane, octadec-17-enylmethyldimethoxy-silane, octadec-17-enylmethylmethoxyethoxysilane and octadec-17-enylmethyldiethoxysilane are selected as silanes of the general formula IV.

During or after its production by radical copolymerization with other olefinically unsaturated compounds or with further silanes which bear olefinically unsaturated groups, the highly branched or hyperbranched polyolefin can be modified, for example by grafting as described above.

At least one silane or two or more silanes, which has (i) at least one olefinically unsaturated C═C double bond and (ii) at least one silicon atom which bears at least one hydrolyzable group, are copolymerized in a radical copolymerization with at least one, two or more olefinically unsaturated monomers of the structure H₂C═CHR^{a}, as a result of which silane group-containing polymers (P) are obtained. In this way, a mixture containing 100 parts by weight of olefinically unsaturated monomer, preferably ethene, with at least 0.1, in particular at least 0.5, particularly preferably at least 1 part by weight and preferably at most 40, in particular at most 30, particularly preferably at most 20 parts by weight of silane and preferably at least 0.01, in particular at least 0.03 parts by weight and preferably at most 5, in particular at most 1 part by weight of radical initiator which releases radicals under the selected reaction conditions is preferably reacted.

By selection of the reaction conditions of the radical copolymerization, the degree of branching of the polymer (P) produced can be controlled: the lower the pressure and/or the higher the temperature, the higher the degree of branching of the resulting polymer and vice versa. The radical copolymer-ization is performed at temperatures of at least 150° C., preferably at least 180° C., in particular at least 210° C. and at most 360° C., preferably at most at 330° C., in particular at most 300° C. The radical copolymerization is preferably performed under elevated pressure, at more than 10 MPa absolute, preferably at more than 25 MPa, in particular at more than 40 MPa and at 500 MPa absolute at most, in particular at 300 MPa at most, in particular at 200 MPa at most.

As radical initiators, for example the same initiators as are described above for the radical grafting can be used in this process. Further, the copolymerization can be started through the presence of oxygen, which for example in the presence of ethene can form ethene hydroperoxide, which can act as an initiator. By selection of the initiator, the degree of branching of the resulting polymer can be influenced: if different initiators are compared, then a lower initiator half life at comparable temperature under comparable polymerization conditions leads to a polymer with a lower degree of branching and vice versa.

Regulators can optionally be added, such as for example saturated or unsaturated hydrocarbons, alcohols, ketones, chlorohydrocarbons, thio compounds, thiols or aldehydes. A regulator can for example influence the molecular weight distribution and the degree of branching of the product.

The conditions of the copolymerization are adjusted such that the product has degrees of branching r greater than or equal to 0.02, preferably greater than or equal to 0.04, in particular greater than or equal to 0.06. These values of r correspond to degrees of branching of 20 or more, preferably of 40 or more, in particular 60 or more branchings per 1000 polymerized olefin monomers. On the basis of the description and on the basis of orienting experiments, those skilled in the art can easily determine how pressure, temperature, initiator and regulator and the concentrations thereof in the production of polymers (P) by radical copolymerization are to be selected in order to achieve the desired degree of branching.

The radical copolymerization is preferably conducted in liquid or gaseous phase or in a multiphase mixture, for example in a smoke, mist, suspension or emulsion or a mixture of several of these multiphase mixtures. The radical copolymerization can be performed in batch processes, for example in kettle reactors or autoclaves, or continuously, for example in pipe reactors. By selection of the reactor, the degree and nature of branching of the product can be additionally controlled. Thus for example pipe reactors with plug flow create fewer long chain branchings than stirred kettles with reconversion (Hans-Georg Elias, Makromoleküle, Vol. 3, Industrielle Polymere and Synthesen, 6^{th} Edition (German), Wiley-VCH Verlag GmbH, Weinheim, 2001, ISBN 3-527-29961-0, Chap. 5.2.3., see in particular p. 157).

Initiator half lives for various temperatures can be obtained from the literature or can be calculated from literature values for the decomposition rates, see for example D. Munteanu, in Plastics Additives Handbook, 5th Edition, Hanser-Verlag, Munich 2001, p. 739-754, or the brochure “Initiators for high polymers” from Akzo Nobel (Issue: June 2006; Code: 2161 BTB Communication, © 2006 Akzo Nobel Polymer Chemicals, see http://www.akzonobel-polymerchemicals.com/NR/rdonlyres/C2D64A96-B539-4769-A688-2447258D3DCA/0/Initiatorsfor HighPolymersAkzoNobe12006.pdf) or see Polymer Handbook, Fourth Edition, Volume 1, J. Brandrup, E. H. Immergut, E. A. Grulke (Eds.), Wiley-Interscience, John Wiley & Sons, Hoboken, N.J., p.II/1-II/76; knowledge of the activation energy of the initiator decomposition enables the calculation of the half lives at different temperatures (for the calculation see the literature cited or http://www.arkema-inc.com/index.cfm?pag=353, see the document “Half life selection guide” downloadable there). Preferably, the combination of temperature in the copolymerization and initiator is selected such that the initiator has a half life of preferably at least 0.01 seconds, in particular at least 0.1 seconds, and of preferably at most one hour, in particular at most 0.1 hours.

The polymer (P) can be used or applied alone or in mixtures optionally with further additives, for example as binding agents or in particular as a reactive melt adhesive; in this sense, a reactive melt adhesive is a special case of a binding agent. Reactive melt adhesives are characterized in that as the finished preparation they have a melting point and a solidific-ation point of at least 30° C., preferably at least 50° C., and are meltable at temperatures lying above this. In the melted state, they can be processed as a liquid, and on cooling below their solidification point they again solidify.

A subject of the invention are binding agents which contain at least one polymer (P).

Thus in the production of the polymer (P) by grafting or by copolymerization before, during or after the grafting reaction or the copolymerization, either in the same step or in an upstream or downstream process step, one or more further additives can be mixed in so that a mixture of the polymer (P) with these additives is obtained.

For example, for adjustment of properties which are necessary or beneficial for the particular application, such as for example viscosity, adhesive strength, initial adhesion, hardness, elasticity, impact resistance, temperature, light or oxidation stability, substances such as adhesive resins, waxes, plasticizers, heat, radical or light stabilizers, brighteners, antistatic agents, parting and antiblocking agents, adhesion promoters such as for example organofunctionalized silanes, e.g. alkoxysilanes which have amino, methacryl, epoxy, alkyl, aryl or amino functionalities, fillers and dyes, pigments, flame retardants, radical absorbers or antioxidants can be added to the polymer (P).

Examples of suitable adhesive resins are natural or synthetic resins, terpene resins, “rosin” resins, liquid resins, hydrocarbon resins, completely or partially hydrogenated resins, for example colophony glycerin or pentaerythritol ester resins, and unhydrogenated, partially hydrogenated or fully hydrogenated aliphatic or aromatic hydrocarbon resins.

As waxes, for example microcrystalline waxes, natural or synthetic waxes, Fischer-Tropsch waxes or polyolefin waxes can be used. Suitable adhesive resins are marketed in various subtypes for example under the names Escorez, Eastotac, Regalite, Regalrez, Piccotac, Krystalex, Unitack, Staybelite or Nirez. For a review, see for example the Technical Datasheets from Eastman Chemical Co. Nos. WA-73 and WA-86, available under www.eastman.com (see http://www.eastman.com/NR/rdonlyres/0120E637-5D8F-4180-8C8A-49650DDB5B27/0/WA73.pdf or http://www.eastman.com/NR/rdonlyres/DCE8D914-FB9A-4F60-AF41-24F37DC82F54/0/WA86.pdf)

As plasticizers, for example paraffin oils, mineral oils, paraffins or low molecular weight polymers, for example polyisobutene, can be used.

Further, for example fillers such as magnesium oxide, silica or clay, antioxidants or catalysts can be mixed in, or further non-graftable or graftable or non-copolymerizable or copolymerizable compounds, in particular silanes, can be mixed in or grafted on or copolymerized during the grafting process or during the copolymerization process in the same or a separate step, wherein the graftable silane is grafted on, or wherein the copolymerizable silane is copolymerized.

The admixture of non-graftable and non-copolymerizable, but hydrolyzable silanes, for example hexadecyltrimethoxysilane, hexadecyltriethoxysilane, ethyltrimethoxysilane, isooctyltri-methoxysilane, isooctyltriethoxysilane, octyltrimethoxysilane, octyltriethoxysilane, methyltrimethoxysilane, dimethyldiethoxy-silane or dimethyldimethoxysilane causes retardation of the moisture crosslinking, since these silanes at least partially capture by hydrolysis reactions the water penetrating and necessary for the crosslinking, and they lower the viscosity of the preparation, and they, unlike unreactive oils and similar unreactive viscosity-lowering agents, are advantageously incorporated into the network during crosslinking and hence bleed less or not at all and do not adversely affect the network density. Instead of non-graftable and non-copolymeriz-able, but hydrolyzable silanes, other organic or inorganic compounds which capture water by reaction, adsorption or absorption can also be used, for example acetals, ortho esters, molecular sieves or salts which can bind the penetrating water as water of crystallization or hydrate. Those water absorbers which bear large alkyl or aryl groups are preferably used, so that the phase compatibility with the polymer (P) is improved and the vapor pressure of the water absorber is lowered, in order to prevent premature evaporation of the water absorber. As large alkyl groups in this context, C₂ groups or larger, in particular C₄ groups or larger, and as large aryl groups, preferably C₆ groups or larger or with aryl groups substituted with alkyl groups are preferably used.

The polymer (P) can also be mixed as a blend with other polymers. Examples of polymers which are suitable for the production of such blends are the polymers described above in connection with the production process of the polymers (P) by grafting, which as described above can be mixed with the highly branched or hyperbranched polyolefin HBPO before the grafting; these polymers can optionally also be mixed with the polymer (P) thus obtained after the grafting of the graftable silane onto the highly branched or hyperbranched polyolefin HBPO or after the production of the polymer (P) by copolymerization; these further polymers can optionally likewise contain silane groups—of the same or different types to those present in the polymer (P). Further, the polymer can be mixed with further highly branched or hyperbranched polyolefins HBPO, in particular with highly branched or hyperbranched polyethylenes HBPE. Further, the production of polymers (P) by copolymeriz-ation described above can be performed in the presence of such polymers, so that the blends are obtained directly from the process.

The use of polymers (P) as binding agents can take place alone or in formulations with additives. Polymers (P) or mixtures containing at least one polymer (P) can be used as binding agents, as melt adhesives or as reactive melt adhesives, for the production of adhesive joints, glued structures, coatings, paints, adhesive tapes, adhesive films, pressure-sensitive adhesives or foams. The polymers (P) are preferably used as reactive melt adhesives or as a component of reactive melt adhesives.

The binding agents or reactive melt adhesives can be used without further additives or in formulations for many applications. For example, adhesive bonds in automobile production, furniture production, in the construction of electrical or electronic devices, in aircraft production, in medical fields, composite materials, multilayer adhesive bonds, bullet-proof glass or other armor-plating, gaskets, seals and coatings may be mentioned.

The unformulated or formulated polymers (P) and binding agents or melt adhesives produced therefrom or preparations thereof can be portioned. Thus as such or as a mixture with further additives they can be filled for example as a melt and optionally cooled, which for example after the cooling yields solidified cast blocks, or for example mechanically granulated, milled, broken, cut, rolled, pressed or extruded from the solid, crystallized or precipitated from the melt or from the solution, pelleted, cooled liquid or semi liquid as drops into pellets optionally on a support material or dissolved from the liquid or solid state by the action of a solvent or applied for example by knife onto supporting sheets, so that for example rods, bars, plates, films, pellets, flakes, granules, powders, blocks, solutions or melts are obtained as delivery forms, which can optionally be filled into ready-to-use containers such as for example cartridges or into containers such as drums, sheets, sacks or bags, which preferably protect against the ingress of atmospheric moisture. As additives, for example catalysts, drying agents, antioxidants or antiblocking agents can be mixed in. Steps such as the portioning, mechanical crushing, dissolution, molding, filling, storage, delivery and use preferably take place under an inert gas atmosphere, which preferably has a water content of less than 1000 ppm, in particular less than 100 ppm. The inert atmosphere preferably contains mostly nitrogen or argon. In this sense, inert means a low water content; at the same time the inert atmosphere can contain oxygen, oxygen contents less than 5 vol. %, in particular <1 vol. %, being preferable.

The unformulated or formulated polymers (P) and binding agents or melt adhesives produced therefrom or preparations thereof containing at least one polymer (P) can be implemented as one-, two- or multicomponent systems. In a one-component system, the desired components are mixed some time before use, as a rule by the manufacturer of the one-component system. In particular, with a one-component system the component which contains the polymer (P) is mixed with a catalyst; the steps which such a catalyst can catalyze are presented further below in connection with the embodiment of a two- or multicomponent system. If a two- or multicomponent system is implemented, then the components are delivered individually to the user and as a rule mixed by the user shortly before use, i.e. as a rule less than 24 hours, preferably less than 60 minutes or less than 60 seconds before use. One embodiment for a two-component system is a system of one, two or more containers, for example a cartridge with two compartments, where the components are mixed on or after expulsion from the vessels or compartments, and then used in the application. If a two- or multicomponent system is implemented, then preferably one (P)-containing component contains no or less added catalyst than at least one further other component which contains at least one catalyst which catalyzes at least one step selected from (i) the hydrolysis of the silane groups in the structural elements R^{Si} of a polymer (P) under the action of moisture, (ii) the condensation of as a rule partially or completely hydrolyzed structural elements R^{Si} of a polymer (P) with further unhydrolyzed or partially hydrolyzed or completely hydrolyzed structural elements R^{Si} of a polymer (P) or (iii) the condensation of unhydrolyzed, partially hydrolyzed or completely hydrolyzed structural elements R^{Si} of a polymer (P) with for example hydroxyl or oxide groups on substrate surfaces, where that component which contains the polymer (P) preferably contains no added catalyst. With implementation as a multicomponent system, at least one-component contains at least one polymer (P).

The devices used for the production of the polymers (P) or of the melt adhesives or binding agents can be cleaned after one, two, three, four, five or more production cycles with for example one or more polymers used for the grafting, with solvents such as for example hydrocarbons or hydrocarbon mixtures, which preferably have boiling points above the melting point of the polymer (P) produced or the melting point of the highly branched polyolefin used (when the polymer (P) was produced by grafting), or with special cleaning agents such as for example Asaclean® or with a combination of several cleaning agents used simultaneously or successively. The devices used for the production of the polymers (P) or of the melt adhesives or binding agents are preferably dried before use.

In the production process of the polymers (P) or of the melt adhesives or binding agents the desired heat input or removal can for example take place from outside or from inside, for example via the device wall or the stirrer or in the case of heat input by shearing. The thermal energy can for example be transferred via steam, superheated steam, hot water, heat transfer oil, brines, electromagnetic radiation or electrically.

The polymers (P) or the melt adhesives or binding agents can for example contain residual contents of ungrafted silane, unreacted peroxide, decomposition products (hydrolysis and condensation products of the silane or of the polymer (P), peroxide fragments, fragments of the grafting base, monomers used for the copolymerization or oligomers thereof). These can optionally remain in the product or be removed from the polymer (P) or from the melt adhesive or binding agent before, during or after the admixture of further ingredients (e.g. adhesive resin, waxes, catalysts), which for example in the case of volatile compounds can take place by application of vacuum, preferably 0.01-500 mbar, in particular 0.1-100 mbar or for example by heating, preferably at 60-350° C., in particular at 100-250° C., or by filtration, for example through a sieve or by combination of several methods, for example application of vacuum and simultaneous heating.

The polymer (P) can be crosslinked with water.

Also a subject of the invention is a process for the cross-linking of the polymer (P) or of mixtures containing at least one polymer (P), optionally in binding agents or in reactive melt adhesives which have at least one polymer (P) as a component or consist of at least one polymer (P), with water.

The water necessary for the crosslinking can be used as vapor and/or liquid water or be provided by atmospheric moisture.

Preferably the crosslinking begins on or after the creation of an adhesive bond or on or after the creation of a coating. The process for the crosslinking can be conducted with no catalyst or in the presence of one or more catalysts. The catalysts can effect an acceleration of the moisture crosslinking of the polymers (P) as such or in preparations or mixtures containing at least one polymer (P), by catalyzing the hydrolysis of the hydrolyzable silane groups contained in the polymer (P) under the action of water and/or the condensation thereof to siloxanes. Further, the catalysts can effect an improvement in the adhesion of the polymer (P) or of preparations or mixtures containing at least one polymer (P), for example in that they catalyze the condensation of the silane groups in the polymer (P) for example with hydroxyl groups or oxide groups on substrate surfaces. In other words, the catalysts catalyze at least one step selected from (i) the hydrolysis of the silane groups R^{Si} of a polymer (P) under the action of moisture, (ii) the condensation of as a rule partially or completely hydrolyzed silane groups R^{Si} of a polymer (P) with further unhydrolyzed or partially hydrolyzed or completely hydrolyzed silane groups R^{Si} of a polymer (P) or (iii) the condensation of unhydrolyzed, partially hydrolyzed or completely hydrolyzed silane groups R^{Si} of a polymer (P) with hydroxyl or oxide groups on substrate surfaces (S) or on the surface of crosslinked substrates (SV). Hydroxyl groups or oxide groups on substrate surfaces in this sense can also be SiOH groups or Si0 groups on further added polymers, when these bear the corresponding functions or silane functions with hydrolyzable Si-bonded groups and moisture acts [on them].

In the moisture crosslinking of the polymer (P) or of prepar-ations or mixtures containing at least one polymer (P), the crosslinked polymer (PV) is formed. Polymers (P) are moreover also capable of condensing with oxide groups or hydroxyl groups other than water or SiOH; likewise polymers (PV), when they still bear reactive silane groups, i.e. are not yet completely crosslinked. If a mixture component or a substrate (S) contains hydroxyl groups or oxide groups and if the polymer (P) or partially crosslinked polymers (PV) or preparations or mixtures containing at least one polymer (P) or partially crosslinked polymer (PV) are applied onto its surface, then condensation products [(P)(S)] and [(PV)(S)] are formed. If the substrate itself is moisture-crosslinkable, then on entry of water the condensation products of the crosslinked substrate (SV) with (P) or with (PV), namely [(P)(SV)] and [(PV)(SV)] are formed. The hydrolysis and/or condensation of the substrate (S) to (SV) is as a rule catalyzable analogously to the condensation of (P) to (PV). Likewise, an already partially crosslinked or completely crosslinked substrate (SV) can be brought into contact with a mixture containing at least one polymer (P) or at least one not yet completely crosslinked polymer (PV), in order to obtain [(P)(SV)] or [(PV)(SV)]. Likewise, instead of partially crosslinked polymers (PV), completely crosslinked polymers (PV) can also be used in order to produce the compounds [(PV)(SV)] or [(PV)(S)], in that the compounds [(PV)(SV)] or [(PV)(S)] are produced with rearrangement of the siloxane groups in (PV). (P) can be converted into (PV) by the action of moisture. [(P)(S)] can be converted by the action of moisture into [(PV)(S)], into [(P)(SV)] or into [(PV)(SV)] or in a mixture of these. [(PV)(S)] can be converted by the action of moisture into [(PV)(SV)]. [(P)(SV)] can be converted by the action of moisture into [(PV)(SV)]. The condensation products and the crosslinked polymers (PV), [(P)(S)], [(PV)(SV)], [(P)(SV)] and [(PV)(S)] are also a subject of the invention.

The production of the hydrolysis or crosslinking or condens-ation products is preferably effected at 0° C. to 200° C., in particular at 10° C. to 140° C. Optionally, artificial moistening, for example by dipping into liquid water or misting or steaming can be effected, for example for acceleration.

In this, at least one polymer (P) or one preparation or mixture containing at least one polymer (P) is for example mixed preferably in the melt, with a catalyst or with a master batch of the catalyst, i.e. a mixture of the catalyst with a suitable polymer of the same or different nature which preferably contains 100 parts by weight of polymer and 0.1-20 parts by weight of the catalyst. Preferably, the crosslinking of the polymer (P) or of a preparation or mixture containing at least one polymer (P) is conducted with at least 0.0001, in particular at least 0.001, especially preferably more than 0.01 weight % and preferably at most 5, in particular at most 1, especially preferably less than 0.1 weight % of catalyst. As catalysts, for example organotin compounds, such as dibutyltin dilaurate, dioctyltin dilaurate, dibutyltin oxide, dioctyltin oxide, tin salts, such as for example tin(II) isooctanoate, titanium compounds, such as for example titanium(IV) isopropylate, aza compounds, such as 1,8-diazabicyclo[5.4.0]-undec-7-ene, 1,5-diazabicyclo[4.3.0]non-5-ene or 1,4-diaza-bicyclo[2.2.2]octane, bases, for example organic amines, such as triethylamine, tributylamine or ethylenediamine, or inorganic or organic acids, such as toluenesulfonic acid, dodecylbenzenesulfonic acid, stearic acid, palmitic acid or myristic acid or anhydrides thereof are usable.

The crosslinked polymer (PV) preferably has a gel content, determined by extraction by the procedure in DIN EN 579, of more than 25%, in particular of more than 50%. The gel contents of crosslinked polymers (PV) can for example be increased by increasing degree of grafting or by the extent of the cross-linking, which can be controlled via the increasing ingress of moisture, and vice versa. If a binding agent which was produced with use of the polymer (P) contains further fractions, then these can influence the measurement results relating to the gel content of the crosslinked polymer (PV), depending on whether the further components of the preparation are also detected by the procedure after DIN EN 579 or not, which can easily be determined by those skilled in the art by subjecting each of the further components of the preparation on its own to a gel content determination, if necessary after moisture aging. The measured values can then be corrected accordingly.

Those skilled in the art can easily themselves determine, through indicative experiments, whether in the particular intended application a crosslinking retardant, in particular a water absorber, or a crosslinking accelerator, in particular a catalyst, is necessary or beneficial.

The crosslinking of the polymer (P) or of mixtures containing at least one polymer (P), optionally in binding agents or in reactive melt adhesives which contain polymer (P) as a component, with water is preferably performed partially or completely on or after the creation of an adhesive joint, a glued structure or a coating.

The binding agents or reactive melt adhesives which consist of at least one polymer (P) or which contain at least one polymer (P) can be used for the production of coatings or adhesive bonds of a great variety of substrates, firstly nonpolar to polar substrates and substrates with reactive surfaces, above all with surfaces which are of an oxide or hydroxylated nature, so that the oxide groups and/or the hydroxyl groups of the substrate form stable bonds with the alkoxysilane groups in the polymer (P) by condensation reactions. At the same time, the polymer (P) creates strong adhesion to nonpolar or polar substrates without oxide or hydroxylated surfaces. Reactive melt adhesives which contain at least one polymer (P) or consist of at least one polymer (P) are therefore suitable for stable and in particular rapid adhesive bonding of substrate combinations of substrates both with hydroxylated/oxide and also with nonpolar surfaces, so that even difficult coatings or adhesive bonds in all possible substrate combinations can be produced with the binding agents or reactive melt adhesives which consist of the polymer (P) or which contain the polymer (P).

Examples of substrates with oxide or hydroxylated surfaces are wood, glass, metals (e.g. titanium, vanadium, chromium, manganese, iron, cobalt, nickel, copper, zinc, silver, silicon, germanium, tin, lead, aluminum, anodized aluminum, magnesium, molybdenum or tungsten), alloys (for example of the aforesaid metals, e.g. brass, bronze, steel or stainless steel), mineral surfaces (e.g. concrete, plaster, rock, artificial rock, stucco, sandstone, clay, marble or granite), graphite, paper and packaging materials; these substrates are examples of substrates (S) according to the above definition. Examples of nonpolar or polar substrates are polyolefins, poly-α-olefins, polyethylene, polypropylene, ethene-propene copolymers, polyvinyl acetate, ethene-vinyl acetate copolymers, ethene-vinyl ether copolymers, polyester, polyamide (Nylon®- or Perlon® type), acrylate polymers and acrylate copolymers, polyalkylene oxides such as polyethylene oxide or polypropylene oxide or polyethers, for example from tetrahydrofuran, or blends or copolymers or graft copolymers from the aforesaid polymers in all combinations. The substrates can be present as mixtures, such as for example as filled polymers such as talc-, graphite- or glass fiber-filled polyolefin, polyethylene, polypropylene or ethene-propene copolymer. Optionally, the substrates can be pretreated with primers such as for example solvents (for example tetrahydro-furan) or adhesion promoters.

The binding agents or reactive melt adhesives can be applied onto one substrate surface or both substrate surfaces as a melt, solution or emulsion and the substrate surfaces can be brought into contact immediately or later, optionally with heating (in this case optionally melting of the binding agent); however for the production of coatings the second substrate surface or the bringing into contact of several substrates do not apply when a coating of only one substrate is desired, and not adhesive bonding of several substrates.

For the processing of the new reactive melt adhesives which consist of at least one polymer (P) or which contain at least one polymer (P), for example for the production of adhesive bonds or of glued structures, processes such as are used in the state of the art for the production of adhesive bonds or of glued structures by means of the already known melt adhesives can be used, wherein only the processing technology is known, but the new reactive melt adhesives display a new property profile which achieves the objective of the invention. The reactive melt adhesive which consists of at least one polymer (P) or which contains at least one polymer (P) is preferably applied onto one side or both sides of the adhesive joint, at temperatures which ensure the moldability or flowability or sprayability of the reactive melt adhesive, and the substrates to be glued are brought together at the adhesive joint. Examples of processes for the application of the reactive melt adhesive are injection processes, knife application or spraying, optionally in combination with mechanical jointing techniques such as for example clinching. The adhesive joint is then crosslinked by water aging, preferably with maintenance of the shape, if necessary taking account of shrinkage or expansion. Processes for moisture crosslinking are described further above. The water or moisture aging preferably takes place initially at a temperature below the solidification—temperature of the still uncrosslinked or only partially crosslinked reactive melt adhesive, so that this presents sufficient initial mechanical strength to enable mechanical clamping devices which fix the substrates to be glued in the desired configuration to be omitted or to reduce the expenditure for the necessary mechanical clamping devices.

All the above symbols in the above formulae each have their meanings independently of each other. Unless otherwise stated, the above information in % means percentages by weight. In all formulae, the silicon atom is tetravalent.

### EXAMPLES

All information in parts stated below means parts by weight. In all the cases presented, the statement “day 0” means determination of a measured value before the start of aging under the particular standard climate conditions stated.

### Production of Polymers (P)

Silane Graftings onto Polymers

### Peroxide

For the experiments, 2,5-bis(tert-butylperoxy)-2,5-dimethyl-hexane was used as the peroxide (Luperox® 101 from Arkema).

### Silane

The silane used is characterized and named as follows:
Silane A: Vinyltrimethoxysilane (“VTMO” or “VTMS”) (GENIOSIL® X 10 from Wacker Chemie Ag) Structure: H₂C═CH—Si(OMe)₃
Silane B: Vinyltriethoxysilane (“VTEO” or “VIES”) (GENIOSIL® GF 56 from Wacker Chemie AG) Structure: H₂C═CH—Si(OEt)₃

### Degrees of Branching

The degree of branching of the polymers used for grafting was determined by nuclear magnetic ¹H resonance spectroscopy CH NMR) and was supported by ¹³C resonance spectroscopy (C NMR) and C,H correlation experiments. For the determination of degrees of branching and of the structure and relative position of branchings in polyolefins by NMR see for example: D. E. Axelson, G. C. Levy, L. Mandelkern, “A Quantitative Analysis of Low-Density (Branched) Polyethylenes by Carbon-13 Fourier Transform Nuclear Magnetic Resonance at 67.9 MHz”, Macro-molecules, 1979, 12 (1), 41-52. J. V. Prasad, P. V. C. Rao, V. N. Garg, “Quantification of Branching in Polyethylene by ¹³C NMR Using Paramagnetic Relaxation Agents”, Eur. Polym. J. 1991, 27 (3), 251-254. Takao Usami, Shigeru Takayama, “Fine-branching structure in high-pressure, low-density polyethylenes by 50.10-MHz carbon-13 NMR analysis”, Macromolecules, 1984, 17 (9), 1756-1761. Johannes Heinemann, “Herstellung von linearen, ver-zweigten and funktionalisierten Poly(ethen)en sowie von poly-olefin-Nanocompositen durch katalytische Ethenpolymerization”, Dissertation, Albert-Ludwigs-Universität Freiburg im Breisgau, Germany, 2000. Since branchings on polyolefins as a rule end with CH₃ groups, in the present text degrees of branching were determined by quantitative evaluation of the integral of the CH₃ resonance in the ¹H NMR.

### Determination of the Grafting Result: Content of Grafted Silane

The grafted silane contents were determined by inductively coupled plasma measurement (“ICP”; element to be quantified: Si). The ICP measured value (weight % Si) was obtained to the concentration of grafted silane (weight % silane) by multiplication by the factor F=[M(silane)/28.0855 g/mol], wherein M(silane) is the molecular weight of the grafted silane and 28.0855 g/mol the relative molar weight of the element silicon (analyte).

### Determination of the Grafting Result: Crosslinkable Fraction

The crosslinkable fraction of a sample was determined by mixing a melt of the polymer sample with ca. 0.1% of dioctyltin dilaurate. This was allowed to cool and the sample was cut into pegs (˜1×0.2×10 mm) which were then stored at 90° C. in water. At time intervals of several hours, pegs were taken out and boiled in stabilizer-containing xylene as per DIN EN 579 in order to determine the gel content of the samples. After a certain water aging time—as a rule after 16 hours at the latest—the gel content increased no further. This gel content was defined as the crosslinkable fraction of the polymer sample. The determinations of the crosslinkable fractions are examples of the crosslinking according to the invention of polymers (P) according to the invention.

### Viscosity

The stated viscosities were determined isothermally at the respective stated temperatures by rotation viscosimetry (cone 1° with 20 mm diameter/plate, shear rate 20 1/s, gap width 0.03 mm, preshear application period 10 s, 15 measured values) on an instrument from Bohlin Instruments (Type CVO 75).

Melting Point (M.Pt.)/melting Range (M.R.)

Melting ranges were determined by differential scanning calorimetry. Two runs (temperature low-->high-->low-->high) were performed. The DSC peak (endothermic) up to the end of the endotherm (boundary of the DSC peak) from the second run was defined as the melting range.

### Molecular Weights

Molecular weights of polymers were determined by high temperature gel permeation chromatography against polyethylene standard (column, 2×Polefin XL 10μ from Polymer Standard Services (PSS) connected in series, column dimensions 2×300 mm×8 mm, temperature 160° C., injection volume 200 μL, sample concentration 1-2 mg/mL in the eluent, eluent 1,2,4-trichloro-benzene (stabilized with 125 ppm BHT), flow rate 1 mL/min, triple detector (light scattering) 15°/90° and are stated as number average Mₙ and as weight average M.

The grafted polymers obtained were kept under blanket gas (nitrogen or argon) with exclusion of moisture.

### Example 1a-c

### Production of a Polymer (P) by Radical Grafting of Silane A onto Polymer in a Batch Process (According to Invention)

Highly branched polyethylene (HBPE, R^{a}═H) of low density was used as the grafting base. According to the manufacturer's information, the polyethylene is characterized by a melt index of 2250 g/10 min (2.16 kg/190° C.), a viscosity of 3550 mPa·s (190° C.), number average molecular weight Mₙ=7700 g/mol and weight average M_{w}=35000 g/mol, a density of 906 kg/m³ and a softening point of ca. 102° C. (ring and ball). It is a product from Westlake with the trade name Epolene® C-10. This grafting base corresponds to the criteria defined above for HBPE and hence also for HBPO. By ¹H NMR (solution in CCl₄ with addition of d6 benzene as lock substance, measurement temperature 60° C.) a degree of branching of 45 branchings per 1000 C atoms was found; this on average corresponds to 90 branchings per 1000 molecules of the underlying monomer ethene or a value of 0.090 for r. The grafted products produced from this display the same or a similar (as a rule ±10%) degree of branching.

### Example 1d

### Production of a Polymer (P) by Radical Grafting of Silane A Onto Polymer in a Batch Process (According to Invention)

Highly branched polyethylene (HBPE, R^{a}═H) of low density was used as the grafting base. According to the manufacturer's information, the polyethylene is characterized by a melt index of 4200 g/10 min (2.16 kg/190° C.), a viscosity of 1800 mPa·s (190° C.), number average molecular weight Mₙ=6700 g/mol and weight average M_{w}=17000 g/mol, a density of 906 kg/m³ and a softening point of ca. 101° C. (ring and ball). It is a product from Westlake with the trade name Epolene® C-15. This grafting base corresponds to the criteria defined above for HBPE and hence also for HBPO. By ¹H NMR (solution in CCl₄ with addition of d6 benzene as lock substance, measurement temperature 60° C.) a degree of branching of 49 branchings per 1000 C atoms was found, this corresponds on average to 98 branchings per 1000 molecules of the underlying monomer ethene or a value of 0.098 for r. The grafted products produced from this display the same or a similar (as a rule ±10%) degree of branching.

### Example 1e

### Production of a Polymer (P) by Radical Grafting of Silane B Onto Polymer in a Batch Process (According to Invention)

The same highly branched polyethylene (HBPE) as in example 1a-c was used as the grafting base.

The grafting reactions of examples 1a-e were performed in batch preparations under blanket gas (argon or nitrogen). Silane and peroxide were mixed. The mixture was fed into the melted polyethylene (180° C.) with stirring over a period of 15-20 minutes and the mixture was stirred for 20 minutes more. Then ungrafted silane was removed under vacuum at 180° C. and the melt was cooled. Proportions used and the characterization of the products are stated in Table 1.

### Example 1f

### Production of a Polymer (P) by Radical Grafting of Silane A onto Polymer in a Continuous Process (According to Invention

The same highly branched polyethylene (HBPE) as in example 1a-c was used as the grafting base. A melt of the polyethylene was extruded at 30 revolutions per minute on a corotating twin-screw extruder from Thermo Electron (L:D=40:1, D=12 mm, 10 zones). The polyethylene was fed in at 7.48 g/min. The silane/peroxide mixture (weight ratio: 8.75:0.15) was fed into zone 3 at 0.68 g/min (corresponding to 0.6685 g/min silane and 0.0115 g/min peroxide), the screws in zone 4 were equipped with mixer elements, and all other screw elements consisted of impellers. Temperature distribution from intake (water-cooled) in nozzle direction per zone: 140/140/140/200/200/200/200/200/200/200° C. The vacuum-degassed extrudate was characterized before use. Proportions used and the characterization of the products are stated in Table 1

### Example 1g

### Production of a Polymer (P) by Radical Grafting Of Silane B onto Polymer in a Continuous Process (According to Invention)

The same process as described in example 1f was used. Poly-ethylene feed: 7.45 g/min; silane/peroxide mixture feed (weight ratio: 11.23:0.10): 0.88 g/min (corresponding to 0.8722 g/min silane and 0.0078 g/min peroxide. The vacuum-degassed extrudate was characterized before use. Proportions used and the characterization of the products are stated in Table 1.

### Example 1v

### Comparative Example to Example 1a-g

### Ungrafted Polymer (Grafting Base) (Comparative Example not According to the Invention)

As a comparative example not according to the invention, designated below as example 1v (not according to invention), the unmodified polymer Epolene® C-10 as defined above was used. The relevant analytical data are stated in Table 1. These data are measured values which were determined by the methods described above (in some cases deviating from the corresponding manufacturer information).

### Example 1w

### Comparative Example to Example 1a-g

### Ungrafted Polymer (Grafting Base) (Comparative Example not According to the Invention)

As a comparative example not according to the invention, designated below as example 1w (not according to invention), the unmodified polymer Epolene® C-15 as defined above was used. The relevant analytical data are stated in Table 1. These data are measured values which were determined by the methods described above (in some cases deviating from the corresponding manufacturer information).

The gel contents of the polymers from example 1a-g, 1v and 1w, determined as per DIN EN 579, were in all cases 0-1%.

TABLE 1
Graftings of silane A or B onto highly branched polyethylene according to the procedures example 1 a-g.

| | | | | Grafted | | | | | | | |
|---|---|---|---|---|---|---|---|---|---|---|---|
| | HBPE | Silane | Peroxide | silane in | Dynamic | Cross | M.R. | Heat of | | | |
| | weight | A or B | weight | grafted | viscosity | link- | (endothermic | fusion | Crystal- | | |
| | used [g] & | weight used | used | product | η [Pa · s] at | able | DSC | (standard- | linity | | |
| | type | [g] | [g] | *** | 125/150/ | content | peak/end) | ized, | [%] | Mₙ | M_{w} |
| No | ***** | ***** | ***** | (wt. %) | 170/190° C. | [%] | [° C.] | J/g) | **** | [g/mol] | [g/mol] |
| 1a * | 100 | 5.0 | 0.10 | 2.96 | 35.3/17.0/ | 49 | 94/106 | +79.7 | 28 | 6584 | 101497 |
| | (C-10) | (A) | | | 9.7/6.9 | | | | | | |
| 1b * | 1000 | 87.5 | 1.50 | 6.60 | 24.5/12.9/ | 69 | 92/106 | +74.9 | 27 | 14046 | 100988 |
| | (C-10) | (A) | | | 7.7/5.1 | | | | | | |
| 1c * | 1200 | 180 | 2.40 | 11.2 | 28.5/13.1/ | 76 | 91/105 | +66.2 | 24 | 8285 | 62782 |
| | (C-10) | (A) | | | 7.7/5.5 | | | | | | |
| 1d * | 500 | 43.8 | 0.75 | 6.9 | 11.7/5.9/ | 67 | 91/107 | +75.3 | 27 | 11115 | 86827 |
| | (C-15) | (A) | | | 3.7/2.4 | | | | | | |
| 1e * | 500 | 56.2 | 0.75 | 9.6 | 90.9/47.1/ | 67 | 93/104 | +68.5 | 24 | 27115 | 69999 |
| | (C-10) | (B) | | | 30.5/20.8 | | | | | | |
| 1f * | 7.48 | 0.6685 | 0.0115 | 4.2 | 18.8/9.11 | 63 | 93/107 | +80.2 | 29 | 13408 | 105482 |
| | (C-10) | (A) | | | 6.1/4.4 | | | | | | |
| 1g * | 7.45 | 0.8722 | 0.0078 | 9.3 | 39.1/18.3/ | 56 | 94/108 | +72.8 | 26 | 15856 | 99836 |
| | (C-10) | (B) | | | 12.0/9.4 | | | | | | |
| 1v ** | 100 | — | — | — | 18.6/9.2/ | 0 | 93/111 | +81.6 | 29 | 6194 | 59840 |
| | (C-10) | | | | 5.2/3.4 | | | | | | |
| 1w ** | 100 | — | — | — | 9.1/4.8/ | 0 | 92/109 | +76.6 | 27 | 4531 | 45031 |
| | (C-15) | | | | 3.1/2.0 | | | | | | |

* = example according to invention
** = comparative example not according to invention.
*** After the grafting, the silane is present in polyolefin-bound form according to the general formula I; the molecular weight of the silane used before grafting was used for the calculation as described in the section “Determination of the grafting result: content of grafted silane”.
**** Calculated from the heat of fusion; calculation as stated above.
***** Examples 1f and 1g: unit [g/min].

### Example 2

### Production of Coatings; Adhesion Buildup

The polymer from example 1b was melted at 140-160° C. and mixed with 0.05 g of dioctyltin dilaurate per 100 g of grafted product. Samples of the product were poured into aluminum dishes, so that a layer of the polymer of ca. 2 mm thickness was formed. Directly after cooling to room temperature, the coating was no longer detachable (adhesion buildup), instead of detachment of the coating, tearing of the aluminum occurred. A [(P)(S)] bond was thus obtained, wherein (P) is the polymer from example 1b and the substrate (S) is the aluminum dish with oxide surface.

### Example 3

### Crosslinking after Production of a Coating; Buildup of Heat Resistance of a Coating

After its production, the coating from example 2 was aged for 7 days under standard climate conditions according to DIN EN ISO 291 (23° C., 50% relative atmospheric humidity, class 1 limit deviation for temperature and relative humidity) at atmospheric air pressure (one-sided air access to the test piece). After this, the coating was no longer meltable up to at least 140° C. (heat resistance). The coating had been crosslinked by the action of moisture. A [(PV)(S)] bond was thus obtained, wherein (PV) is the crosslinked polymer from example 1b and the substrate (S) is the aluminum dish with oxide surface.

### Comparative Example to Example 2 and 3Ungrafted Polymer (Not According to Invention)

The ungrafted polymer from example 1v (unmodified Epolene® C-10, not according to invention) without dioctyltin dilaurate was poured into an aluminum dish in the same way as described in example 2 or used for the adhesive bonding of two aluminum plates. The coatings easily fell out of the prepared dishes on rotation of the aluminum dishes sometimes under their own weight or could easily be pulled off the aluminum with no residue. Even after aging analogously to example 3, the coating was still meltable at 102-110° C.

### Example 4

### Crosslinking of Polymer (P) to (PV)

The polymers from examples 1b, 1c, 1d and 1e were each melted at 140-160° C., each mixed with 0.05 g of dioctyltin dilaurate (DOTL) per 100 g of grafted product and then compressed at 135° C. into a 1 mm (±0.2 mm) thick plate and cooled. In addition, one sample of the polymer from example 1b was melted at 140-160° C. and mixed with dioctyltin dilaurate (DOTL), 49 g of adhesive resin (Regalite R1100 from Eastman Chemical) and 4.6 g of paraffin wax (Aldrich Art. No. 411663, M.Pt. ≧65° C.) per 100 g of grafted product and analogously compressed to form plates of the same geometry. Test pieces with the dimensions 15 mm×10 mm×1.0 mm (±0.2 mm) were stamped out (typical weight of one test piece: 150 mg (±30 mg)) and aged under standard climate conditions according to DIN EN ISO 291 (23° C., 50% relative atmospheric humidity, class 1 limit deviation for temperature and relative humidity) at atmospheric air pressure (two-sided air access to the test pieces).

Individual test pieces were packed in stainless steel nets of known weight (mₙ) (closure by edge folding), weighed (m₁) and extracted for 4 hours in boiling para-xylene, to which 2,2′-methylenebis(6-tert-butyl-4-methylphenol) (1%) had been added. The para-xylene:sample ratio was 500 parts:1 part. The samples were removed hot, again washed with xylene, dried for 1 hour at room temperature in air and 1 hour more at 140° C. and again weighed (m₂). The gel content is the fraction of the sample insoluble in boiling xylene, which is calculated from

Gel content=1−[(m₁−m₂)/(m₁−mₙ)]

The gel content is stated below in percent [%].

Depending on the aging time under standard climate conditions, the following gel contents were found (mean values each from 4 measurements):

TABLE 2
Change in gel contents over the aging time.

| | Ex. No. | | | | |
|---|---|---|---|---|---|
| | 4b | 4c | 4d | 4e | 4h |
| Polymer from Ex. | 1b | 1c | 1d | 1e | 1b |
| Grams DOTL per | 0.05 | 0.05 | 0.05 | 0.05 | 0.05 |
| 100 grams | | | | | |
| polymer | | | | | |
| Grams resin per | — | — | — | — | 49 |
| 100 grams | | | | | |
| polymer | | | | | |
| Grams paraffin | — | — | — | — | 4.6 |
| wax per 100 | | | | | |
| grams polymer | | | | | |
| Aging time [days] | Gel content [%] | | | | |
| 0 | 0.6 | 0.2 | 0.6 | 0.9 | 0.0 |
| 1 | 16 | 32 | 18 | 0.4 | 7 |
| 2 | 53 | 51 | 45 | 5 | 26 |
| 3 | 54 | | 48 | 3 | 33 |
| 5 | 50 | 67 | 51 | 25 | 32 |
| 7 | 50 | 69 | 53 | 37 | 36 |
| 9 | 58 | 69 | 54 | 31 | 38 |
| 11 | | 69 | | 43 | |
| 12 | 53 | | 58 | | 36 |
| 14 | 59 | 74 | 58 | 42 | 39 |
| 21 | | | | 49 | |
| 28 | | | | 47 | |

Directly after its preparation, the mixture according to example 4 h displayed a viscosity of 8.7/4.2/2.4/1.6 Pa·s at 125/150/170/190° C. The formulation components Regalite R1100 and paraffin wax are completely soluble with a gel content determination as per DIN EN 579. In order to determine the gel content of crosslinked polymer (PV) in the mixture, the gel contents stated in Table 2 for example 4g must therefore be corrected by a factor of (100+49+4.6)/100=1.536 in order to obtain the gel content of the crosslinked polymer (PV) in the mixture, where the summands +49 and +4.6 in the equation stand for the parts by weight of the completely soluble components (Regalite R1100 and paraffin wax).

### Example 5

### Crosslinking of Polymers (P) and Releasable Volatile Organic Compounds (VOC) after Crosslinking with Various Aging Times Under Standard Climate Conditions

The same test pieces as described in example 4 were used and aged analogously to example 4 under identical conditions. After the aging, one test piece each together with 30 μL of water was placed in a headspace GC vial and the vial tightly sealed (water excess relative to theoretical maximum quantity of Si—X bonds present in the material). This test serves to establish the quantity of volatile organic chemicals (“VOC”) present in the material at each aging time point, above all in the form of alkoxy groups bound to silicon and still capable of being released (“releasable alcohol”). From the difference between two measurements, it is possible to calculate how much alcohol was actually released from the sample in the time interval under consideration under the standard climate conditions of the aging. The vials with the enclosed water were heated at 110° C. for 43 hours in example 5b, 5c, 5d and 5 h and for 67 hours in example 5e (complete hydrolysis of the Si—X bonds, clear from the measured values no longer increasing with prolonged heating over 30 hours (Ex. 5b, 5c, 5d, 5h) and over 54 hours (Ex. 5e) respectively) and the quantity of VOC which was released from the sample was determined by calibrated headspace GC. Since in the present example a methoxysilane-grafted or ethoxysilane-grafted highly branched polyethylene was used, the headspace GC method was calibrated on the detection of the hydrolysis product methanol (Ex. 5b, 5c, 5d, 5h) or ethanol (Ex. 5e) respectively.

Depending on the aging time under standard climate conditions the following measured values were found (mean values each from 3 measurements; all stated in ppm methanol per gram polymer (P)):

TABLE 3
Change in releasable alcohol from samples of the polymer (P) over the
aging time. Isocyanates were not detected and, because of the system,
cannot be released from the samples.

| | Ex. No. | | | | |
|---|---|---|---|---|---|
| | 5b | 5c | 5d | 5e | 5h |
| Polymer | 1b | 1c | 1d | 1e | 1b |
| from Ex. | | | | | |
| Grams | 0.05 | 0.05 | 0.05 | 0.05 | 0.05 |
| DOTL per | | | | | |
| 100 grams | | | | | |
| polymer | | | | | |
| Grams resin | — | — | — | — | 49 |
| per | | | | | |
| 100 grams | | | | | |
| polymer | | | | | |
| Grams | — | — | — | — | 4.6 |
| paraffin wax | | | | | |
| per 100 | | | | | |
| grams | | | | | |
| polymer | | | | | |
| Alcohol | methanol | methanol | methanol | ethanol | methanol |
| released | | | | | |
| Aging time | ppm alcohol | | | | |
| [days] | (μg alcohol per gram polymer) | | | | |
| 0 | 34082 | 61474 | 38816 | | 24334 |
| 1 | 32587 | 48382 | 33080 | 46424 | 20025 |
| 2 | 28107 | 52378 | 28876 | 32851 | 18109 |
| 3 | 27064 | | 27762 | 40341 | 17540 |
| 5 | | 31391 | 22461 | 42617 | 15523 |
| 7 | 23640 | 38002 | 21585 | 37603 | 14302 |
| 9 | 19556 | 30930 | 20748 | 41228 | 14249 |
| 11 | | 28413 | | 40169 | |
| 12 | 22169 | | 17507 | | 12624 |
| 14 | 18215 | 21518 | 17249 | 33176 | 12447 |
| 21 | 16619 | 26535 | 16524 | 36865 | 11268 |
| 28 | 16081 | 18560 | 15447 | 30122 | 9594 |
| (Day 14 − | 152 | 211 | 129 | 218 | 204 |
| day 28)/14^{(a)} | | | | | |

For test pieces thinner than ca. 1 mm, a tendency to more rapid decrease in the measured values of [ppm] MeOH over the aging time was observed.
^{(a)}The last row of the table states how much alcohol is released towards the end of the aging time (here: day 14 to day 28) from the particular sample under consideration per aging day. Calculation: the measured values in the table rows above this state the maximum quantity of alcohol still releasable from the samples under consideration at the respective aging time point under totally hydrolyzing conditions (e.g. heat, water excess). How much alcohol was actually released per day under standard climate conditions is calculated by taking the difference in the values at the start and the end of the time period under consideration (here: day 14 to day 28) and dividing by the number of aging days in the time period under consideration (here: 14 days).

### Examples 6 and 7

### Creation of Adhesive Bonds

The polymers from examples 1b, 1c, 1d and 1e were mixed as described in example 4 with dioctyltin dilaurate (DOTL) or with dioctyltin dilaurate (DOTL), Regalite R1100 and paraffin wax, each filled into a cartridge and without further admixtures were used as reactive melt adhesives by means of a melt adhesive gun. The polymer from example 1v and 1w respectively (contains no silane groups, hence not according to invention; no catalyst) served for comparison. In each case, two test pieces with the dimensions 25 mm×100 mm×3 mm (wood (maple)) were glued over an overlap length of 12.5 mm, so that a single-shear overlap joint with an area of 312.5 mm² was created (DIN EN 1465). In further series, two test pieces each with the dimensions 25 mm×50 mm×3 mm and 12.5 mm×50 mm×3 mm (wood (maple)) respectively were glued over an overlap length of 20 mm or 16 mm respectively, so that a single-shear overlap joint with an area of 200 mm² or 500 mm² respectively was created (see Table 4). All adhesive bonds were cooled to room temperature within 5 minutes and during this time were pressed together with the weight force of 1 kg (ca. 9.8 N).

TABLE 4
Adhesive bonds created (Example 6).

| | Ex. No. | | | | | | |
|---|---|---|---|---|---|---|---|
| | | | | | | 6v | 6w |
| | 6b | 6c | 6d | 6e | 6h | ** | ** |
| Polymer from Ex. | 1b | 1c | 1d | 1e | 1b | 1v | 1w |
| | | | | | | * * | ** |
| Grams DOTL | 0.05 | 0.05 | 0.05 | 0.05 | 0.05 | — | — |
| per 100 grams polymer | | | | | | | |
| Grams resin per | — | — | — | — | 49 | — | — |
| 100 grams polymer | | | | | | | |
| Grams paraffin wax per | — | — | — | — | 4.6 | — | — |
| 100 grams polymer | | | | | | | |
| Wood (maple); | x | x | x | x | x | x | x |
| 25 mm × 100 mm × 3 mm; | | | | | | | |
| Overlap length | | | | | | | |
| 12.5 mm | | | | | | | |
| (Glued area: | | | | | | | |
| 312.5 mm²) | | | | | | | |

** Comparative example (not according to invention)

TABLE 5
Adhesive bonds created (Example 7).

| | Ex. No. | | | | | | |
|---|---|---|---|---|---|---|---|
| | | | | | | 7v | 7w |
| | 7b | 7c | 7d | 7e | 7h | ** | ** |
| Polymer from Ex. | 1b | 1c | 1d | 1e | 1b | 1v | 1w |
| | | | | | | ** | ** |
| Grams DOTL | 0.05 | 0.05 | 0.05 | 0.05 | 0.05 | — | — |
| per 100 grams polymer | | | | | | | |
| Grams resin per | — | — | — | — | 49 | — | — |
| 100 grams polymer | | | | | | | |
| Grams paraffin wax per | — | — | — | — | 4.6 | — | — |
| 100 grams polymer | | | | | | | |
| Wood (maple); | x | x | x | x | x | x | x |
| (12.5 mm × 50 mm × | | | | | | | |
| 3 mm); overlap length | | | | | | | |
| 16 mm | | | | | | | |
| (Glued area: 200 mm²) | | | | | | | |

** Comparative example (not according to invention)

### Example 8

### Moisture Crosslinking of Adhesive Bonds and Determination of the Tensile Shear Strengths of the Adhesive Bonds

The test pieces from examples 6b, 6c, 6d, 6e, 6h, 6v and 6w were aged under standard climate conditions according to DIN EN ISO 291 (23° C., 50% relative atmospheric humidity, class 1 limit deviation for temperature and relative humidity) at atmospheric air pressure (two-sided air access to test pieces). The tensile shear strength of the adhesive joints was determined according to DIN EN 1465 at room temperature. Table 6 gives the results after various aging times. Each result presented is a mean value from 5 measurements (exception: omission of defective test pieces). Further, the fracture pattern of the measure-ments is stated as the number of the test pieces in question which break with adhesive fracture (A), cohesive fracture (C) or a mixture of adhesive and cohesive fracture (AC).

TABLE 6
Change in the tensile shear strengths of the adhesive bonds created over the aging time.

| | Ex. No. | | | | | | |
|---|---|---|---|---|---|---|---|
| Aging time | 8b | 8c | 8d | 8e | 8h | 8v ** | 8w ** |
| under std. | Adh. bond from Ex. | | | | | | |
| clim. [days] | 6b | 6c | 6d | 6e | 6h | 6v ** | 6w ** |
| | Tensile shear strength [MPa] (±standard deviation) [MPa]; | | | | | | |
| | number of fracture patterns (abbreviations: adhesive fracture A, cohesive | | | | | | |
| | fracture C, mixed adhesive-/cohesive fracture AC, joined part failure F) | | | | | | |
| 0 | 3.68 ± 0.82; | 2.82 ± 0.26; | 2.70 ± 0.26; | 1.42 ± 0.21; | 2.84 ± 0.14; | 1.19 ± 0.11; | 1.17 ± 0.14; |
| | 5A | 2A 3C | 5C | 5A | 5C | 5A | 5A |
| 1 | 3.63 ± 0.67; | 3.57 ± 0.16; | 3.76 ± 0.48; | 1.76 ± 0.26; | 3.33 ± 0.39; | 1.16 ± 0.15; | 1.03 ± 0.07; |
| | 5A | 1A 4C | 5C | 5A | 5C | 5A | 5A |
| | Tensile shear strength [MPa] (±standard deviation) [MPa]; | | | | | | |
| | resp. number of fracture patterns (abbreviations: adhesive fracture A, cohesive | | | | | | |
| | fracture C, mixed adhesive-/cohesive fracture AC, joined part failure F) | | | | | | |
| 2 | 3.87 ± 0.88; | 3.07 ± 0.53; | 4.00 ± 0.22; | 2.59 ± 0.59; | 3.82 ± 0.25; | | |
| | 3A 2C | 1A 4C | 5C | 5A | 4C 1F | | |
| 3 | 4.52 ± 0.94; | | 4.13 ± 0.15; | 2.33 ± 0.33; | 3.78 ± 0.14; | 1.26 ± 0.22; | 0.94 ± 0.19; |
| | 2A 3C | | 5C | 5A | 5C | 5A | 5A |
| 5 | 3.79 ± 0.77; | 3.39 ± 0.40; | 4.01 ± 0.54; | 2.83 ± 0.66; | 3.94 ± 0.18; | | |
| | 3A 2C | 5C | 5C | 3A 1C | 5C | | |
| 7 | 4.66 ± 0.91; | 4.00 ± 0.34; | 4.27 ± 0.18; | 3.04 ± 1.19; | 4.11 ± 0.23; | 1.41 ± 0.12; | 1.19 ± 0.11; |
| | 5C | 4C | 5C | 3A 1C | 4C 1F | 5A | 5A |
| 9 | 4.20 ± 0.85; | 4.41 ± 0.37; | 3.72 ± 0.59; | 3.06 ± 0.49; | 4.04 ± 0.35; | | |
| | 1A 4C | 3C 1F | 5C | 3A 2C | 5C | | |
| 10 | | | | | | 1.34 ± 0.16; | 1.07 ± 0.13; |
| | | | | | | 5A | 5A |
| 11 | 4.78 ± 0.87; | 4.69 ± 0.60; | | 3.22 ± 0.61; | | | |
| | 5C | 1A 3C 1F | | 3A 2C | | | |
| 12 | | | 4.60 ± 0.25; | | 4.38 ± 0.40; | | |
| | | | 5C | | 5C | | |
| 14 | 3.36 ± 0.59; | 3.73 ± 0.40; | 4.64 ± 0.20; | 3.00 ± 0.77; | 4.37 ± 0.30; | 1.05 ± 0.13; | 1.21 ± 0.19; |
| | 1A 3C 1AC | 3C 2F | 5C | 4A 1C | 5C | 5A | 5A |
| 16 | 4.62 ± 0.96; | | | 3.10 ± 0.64; | | | |
| | 5C | | | 3A 2C | | | |
| | Tensile shear strength [MPa] (±standard deviation) [MPa]; | | | | | | |
| | resp. number of fracture patterns (abbreviations: adhesive fracture A, cohesive | | | | | | |
| | fracture C, mixed adhesive-/cohesive fracture AC, joined part failure F) | | | | | | |
| 19 | 4.17 ± 0.52; | | | 2.11 ± 0.66; | | | |
| | 2A 2C 1F | | | 3A 1C | | | |
| 21 | 4.89 ± 0.26; | | | 3.14 ± 0.59; | | | |
| | 5C | | | 3A 1C | | | |
| 24 | 4.99 ± 0.22; | | | | | | |
| | 5C | | | | | | |
| 28 | 4.99 ± 0.37; | | | 2.94 ± 0.50; | | | |
| | 5C | | | 3A 2C | | | |

** Comparative example (not according to invention)

Examples 8b-e and h show that shortly after creation of the adhesive bonds polymers (P) according to the invention cause better adhesion to wood (maple), which remains unchanged during the aging, than the corresponding polymers not according to the invention without silane groups (see examples 8v and 8w—not according to invention), the adhesion whereof to wood is markedly worse.

### Example 9

### Moisture Crosslinking of Adhesive Bonds and Determination of the Heat Resistance of Adhesive Bonds

The test pieces from examples 7b, 7c, 7d, 7e, 7h, 7v and 7w were aged under standard climate conditions according to DIN EN ISO 291 (23° C., 50% relative atmospheric humidity, class 1 limit deviation for temperature and relative humidity) at atmospheric air pressure (two-sided air access to the test pieces). The test pieces were then loaded with a weight force of 2 kg (corresponding to a weight force of 19.6 N) and heated in a heating cabinet at a heating rate of 5° C./minute. These loadings correspond to a tensile shear of about 0.1 MPa along the main axes of the test pieces. The heat resistance states the temperature at which the adhesive joint tears under this tensile shear. Table 7 shows the results after various aging times (mean values from three experiments). The measurements were stopped on attainment of 250° C. (thermal decomposition of the wood); adhesive bonds which had not yet fractured under the stated shear after 15 minutes at constant 250° C. were included in the mean value calculation with the value 250° C.; the respective number of the test pieces which reached this limit is stated in the table as a value in brackets.

TABLE 7
Change in the heat resistance of the adhesive bonds produced, over the aging time.

| | Ex. No. | | | | | | |
|---|---|---|---|---|---|---|---|
| | 9b | 9c | 9d | 9e | 9h | 9v ** | 9w ** |
| | Adh. bond from Ex. | | | | | | |
| | 7b | 7c | 7d | 7e | 7h | 7v ** | 7w ** |
| Aging time | Tensile shear [MPa] | | | | | | |
| under std. | 0.1 | 0.1 | 0.1 | 0.1 | 0.1 | 0.1 | 0.1 |
| clim. [days] | Heat resistance, mean value in [° C.] (in brackets: number of test pieces ≧250° C.) | | | | | | |
| 0 | 101 (0) | 119 (0) | 105 (0) | 115 (0) | 92 (0) | 97 (0) | 92 (0) |
| 1 | 115 (0) | 129 (0) | 127 (0) | 124 (0) | 112 (0) | 97 (0) | 93 (0) |
| 2 | 132 (0) | 138 (0) | 127 (0) | 124 (0) | 113 (0) | | |
| 3 | 132 (0) | | 124 (0) | 125 (0) | 120 (0) | 95 (0) | 93 (0) |
| 5 | | | 132 (0) | 123 (0) | 127 (0) | | |
| 7 | 132 (0) | 250 (3) | 138 (0) | 127 (0) | 126 (0) | 93 (0) | 87 (0) |
| 9 | 130 (0) | 250 (3) | 128 (0) | 128 (0) | | | |
| 10 | | | | | | 92 (0) | 89 (0) |
| 11 | 127 (0) | 250 (3) | 127 (0) | 127 (0) | | | |
| 14 | 140 (0) | 250 (3) | 127 (0) | 133 (0) | | 93 (0) | 85 (0) |
| 16 | | | | 136 (0) | | | |
| 19 | | | | 139 (0) | | | |
| 21 | | | | 140 (0) | | | |

** Comparative example (not according to invention)

Examples 9b-e and h show that binding agents according to the invention containing at least one polymer (P) (in this specific case: one polymer (P) and one catalyst) directly after the creation of the adhesive bonds (cf. measured values for 0 days aging time) or in formulation (see Ex. 9h) at the latest after one day aging time even with considerably higher tensile shear already display comparable to better heat resistance on wood (maple) than the binding agent not according to the invention which contains no polymer (P) (comparative examples 9v and 9w not according to invention). In the further course of the aging time under standard climate conditions, the binding agents according to the invention containing polymer (P) according to the invention increasingly build up heat resistance and attain very considerably better heat resistances than the binding agents not according to the invention which contain no polymer (P).

The test standard normally used for the heat resistance WPS 68 could not reasonably be used for examples 9b-e, h, since the samples from these examples after a short aging time under standard climate conditions already attained heat resistances of over 250° C. according to WPS 68 (incipient decomposition of the wooden joined parts at 250° C.). For a description of the method WPS 68 see W. Schneider, D. Fabricius, “Methode zur Prüfung der Warmestandfestigkeit von Schmelzklebstoffen fur die holzverarbeitende Industrie (Methode WPS 68)” [Method for the testing of the heat resistance of melt adhesives for the wood-processing industry (Method WPS 68)], Adhasion Kleben & Dichten, 1969, No. 1, p. 28-37.

### Example 10

### Moisture Crosslinking of Polymers (P) and Determination of the Cohesive Strength Depending on the Aging Time Under Standard Climate Conditions

From the plates described in example 4 (the plate materials consisted of the mixtures as described in example 4) test pieces as per DIN 53504, Type S2 were stamped out, which deviated from DIN 53504 only in that they had a thickness of 1.0 mm (±0.2 mm). The test pieces were aged under standard climate conditions according to DIN EN ISO 291 (23° C., 50% relative atmospheric humidity, class 1 limit deviation for temperature and relative humidity) at atmospheric air pressure (two-sided air access to the test pieces). The tensile tear strengths of the test pieces were measured at room temperature as per DIN EN ISO 527. Table 8 gives the results of the maximum tensile stresses measured after various aging times. Each result shown is a mean value from 4 measurements.

TABLE 8
Change in the tensile tear strength (cohesion) of a binding
agent according to the invention over the aging time.

| | Ex. No. | | | | | | |
|---|---|---|---|---|---|---|---|
| | 10b | 10c | 10d | 10e | 10h | 10v ** | 10w ** |
| | Polymer from Ex. | | | | | | |
| | 1b | 1c | 1d | 1e | 1h | 1v ** | 1w ** |
| | Grams DOTL per 100 grams polymer | | | | | | |
| Aging time | 0.05 | 0.05 | 0.05 | 0.05 | 0.05 | — | — |
| under std. | Grams resin per 100 grams polymer | | | | | | |
| clim. [days] | — | — | — | — | 49 | — | — |
| | Maximum tensile stress [MPa] ± standard deviation [MPa]; | | | | | | |
| | Tensile elongation at tear [%] ± standard deviation [% points] | | | | | | |
| 0 | 3.87 ± 0.12; | 3.64 ± 0.08; | 3.05 ± 0.31; | 4.04 ± 0.16; | 2.19 ± 0.07; | 4.50 ± 0.33; | 4.17 ± 0.21; |
| | 51 ± 6 | 50±10 | 29 ± 7 | 89 ± 22 | 50 ± 5 | 28 ± 16 | 39 ± 4 |
| 1 | 4.45 ± 0.09; | 4.57 ± 0.24; | 4.32 ± 0.29; | 4.31 ± 0.36; | 2.44 ± 0.24; | 5.01 ± 0.08; | 4.43 ± 0.20; |
| | 61 ± 11 | 70 ± 30 | 51 ± 15 | 66 ± 24 | 25 ± 3 | 35 ± 10 | 35 ± 6 |
| 2 | 4.63 ± 0.52; | 5.26 ± 0.19; | 4.58 ± 0.24; | 4.61 ± 0.37; | 3.37 ± 0.17; | | |
| | 57 ± 27 | 95 ± 15 | 47 ± 5 | 85 ± 35 | 64 ± 33 | | |
| 3 | 5.16 ± 0.12; | | 4.76 ± 0.14; | 4.30 ± 0.11; | 3.55 ± 0.15; | 4.80 ± 0.16; | 4.38 ± 0.20; |
| | 60 ± 12 | | 62 ± 8 | 72 ± 23 | 98 ± 39 | 35 ± 11 | 34 ± 4 |
| 5 | | 5.97 ± 0.29; | 4.87 ± 0.12; | 5.12 ± 0.30; | 3.43 ± 0.12; | | |
| | | 73 ± 17 | 48 ± 7 | 113 ± 17 | 55 ± 19 | | |
| 7 | 5.44 ± 0.12; | 5.70 ± 0.65; | 5.08 ± 0.24; | 5.10 ± 0.28; | 4.00 ± 0.10; | 5.10 ± 0.46; | 5.01 ± 0.26; |
| | 78 ± 16 | 64 ± 25 | 53 ± 20 | 100 ± 19 | 67 ± 16 | 33 ± 9 | 32 ± 7 |
| | Maximum tensile stress [MPa] ± standard deviation [MPa]; | | | | | | |
| | Tensile elongation at tear [%] ± standard deviation [% points] | | | | | | |
| 9 | 5.28 ± 0.55; | 6.20 ± 0.43; | 5.30 ± 0.39; | 5.33 ± 0.21; | 4.06 ± 0.21; | | |
| | 49 ± 21 | 59 ± 17 | 52 ± 19 | 99 ± 10 | 67 ± 16 | | |
| 10 | | | | | | 5.39 ± 0.23; | 4.77 ± 0.35; |
| | | | | | | 39 ± 7 | 42 ± 14 |
| 11 | | 6.31 ± 0.52; | | 5.13 ± 0.23; | | | |
| | | 72 ± 18 | | 83 ± 19 | | | |
| 12 | 5.56 ± 0.16; | | 5.86 ± 0.15; | | 3.50 ± 0.06; | | |
| | 74 ± 15 | | 45 ± 3 | | 56 ± 16 | | |
| 14 | 5.53 ± 0.14; | 6.53 ± 0.51; | 5.39 ± 0.77; | 4.74 ± 0.16; | 4.15 ± 0.16; | 5.24 ± 0.34; | 4.60 ± 0.55; |
| | 50 ± 11 | 63 ± 20 | 37 ± 8 | 97 ± 21 | 67 ± 6 | 34 ± 9 | 40 ± 5 |
| 16 | | | | 5.30 ± 0.19; | | | |
| | | | | 92 ± 24 | | | |
| | Maximum tensile stress [MPa] ± standard deviation [MPa]; | | | | | | |
| | Tensile elongation at tear [%] ± standard deviation [% points] | | | | | | |
| 19 | | | | 5.25 ± 0.28; | | | |
| | | | | 83 ± 25 | | | |
| 21 | | | | 5.01 ± 0.11; | | | |
| | | | | 71 ± 15 | | | |
| 24 | | | | 5.38 ± 0.19; | | | |
| | | | | 63 ± 27 | | | |
| 28 | | | | 5.44 ± 0.36; | | | |
| | | | | 69 ± 23 | | | |

Examples 10b-e and h show that with the binding agents according to the invention excellent tensile tear strengths are achievable, while at the same time the binding agents according to the invention display low viscosities above their melting point.

Examples 8 and 9 show examples of the crosslinking of adhesive joints, example 3 is an example of the crosslinking of a coating, and examples 4, 5 and 10 show examples of the crosslinking of a binding agent according to the invention, each under the action of moisture.

1. Polymers (P) which contain at least one silane group, wherein at least one silicon atom bears a hydrolyzable group, of the general formula I,
R^{A}[(CH₂)(CHR^{a})]ₚ₋ₕ[(CH₂)ₖ(CR^{c}R^{d})]_{m-g}R^{U}_{g}R^{O}ₜ[(CH₂)ₗ(CR^{f}R^{Si})]_{g+h}R^{B} (I),
wherein R^{A} and R^{B} are monovalent terminal groups,
R^{a} stands for hydrogen or for a hydrocarbon residue,
R^{c} and R^{d} stand for hydrogen or for hydrocarbon residues,
R^{U} stands for an unsaturated di- or trivalent hydrocarbon residue,
R^{O} stands for groups —CH₂—C(H)(OH)—, —CH₂—C(H)(OOH)—, —CH₂—C(═O)—, —C(H)(OH)—, —C(H)(OOH)— or —C(═O)—,
the structure of the groups [(CH₂)ₖ(CR^{c}R^{d})] is not identical with the structure of the groups [(CH₂)(CHR^{a})],
monomers of the structure H₂C═C(H)(R^{a}) were used for the production of the polymers (P) in at least one synthesis step,
monomers of the structure H₂C═C(R^{c})(R^{d}) were used for the production of the polymers (P) in no synthesis step,
the structure of the monomers H₂C═C(H)(R^{a}) is not identical with the structure of the monomers H₂C═C(R^{c})(R^{d}),
g can take integer values greater than or equal to 0,
h can take integer values greater than or equal to 0,
k can take the values 0 or 1,
l can take the values 0 or 1,
m can take integer values greater than or equal to 1,
p can take integer values greater than or equal to 9,
q can take integer values greater than or equal to 0,
t can take integer values greater than or equal to 0,
the sum of g+h takes a value greater than or equal to 1,
the sum of q+p+m+t takes an integer value greater than or equal to 10,
the difference m−g takes a value greater than or equal to 1,
the difference p−h takes a value greater than or equal to 5,
the relationship m−g=r×(m+p+q+t) applies,
r takes a value greater than or equal to 0.02,
R^{f} stands for hydrogen or for a hydrocarbon residue or for a residue R^{Si},
R^{Si} means a silicon-atom-containing group, wherein at least 50 mol. % of all R^{Si} mean a group [—(R²ᵥ—C¹(R³₂))_{w}—R⁴ₓ—SiXₛR¹₃₋ₛ], wherein
R¹ stands for a hydrocarbon residue or for a hydroxyl group or an Si₁-Si₂₀ siloxy residue or a condensed silane hydrolyzate of silanes with 1, 2, 3 or 4 hydrolyzable groups, which can be substituted with Si-bonded groups X, with Si-bonded hydroxyl groups or with C₁-C₂₀ hydrocarbon groups or with groups —C²R³₃, or takes the structure —C²R³₃,
R² stands for a bond or for a C₁-C₂₀ hydrocarbon residue, which can be substituted by one or more monovalent substituents Q¹ or interrupted by one or more divalent groups Q² or interrupted by one or more trivalent groups Q³, wherein, when v is not equal to 0, that atom in R² which is bound to the carbon atom C¹ is a carbon atom,
R³ means hydrogen or a C₁-C₁₈ alkyl or C₆-C₁₀ aryl residue which is unsubstituted or substituted by one or more monovalent substituents Q¹ or interrupted by one or more divalent groups Q² or interrupted by one or more trivalent groups Q³, wherein that atom in R³ which is bound to the carbon atom C¹ or C² is a carbon atom or a hydrogen atom,
R⁴ stands for a divalent siloxane group from a hydrolyzate of silanes with 1, 2, 3 or 4 hydrolyzable groups, which can be substituted with Si-bonded groups X, with Si-bonded hydroxyl groups or with C₁-C₂₀ hydrocarbon groups or with groups —C²R³₃, wherein, when x is not equal to 0, that atom in R⁴ which is bound to the unit SiXₛR¹₃₋ₛ is an oxygen atom, and that atom in R⁴ which is bound to the unit —(R²ᵥ—C¹(R³₂))_{w}— is a silicon atom,
Q¹ stands for a hetero atom-containing monovalent residue selected from the group consisting of fluorine, chlorine, bromine, iodine, cyanato, isocyanato, cyano, nitro, nitrato, nitrito, silyl, silylalkyl, silylaryl, siloxy, siloxanoxy, siloxyalkyl, siloxanoxyalkyl, siloxyaryl, siloxanoxyaryl, hydroxy, alkoxy, aryloxy, acyloxy, S-sulfonato, O-sulfonato, sulfate, S-sulfinato, O-sulfinato, amino, alkylamino, arylamino, dialkylamino, diarylamino, arylalkylamino, acylamino, imido, sulfonamide, mercapto, alkylthio- or arylthio substituents, O-alkyl-N-carbamato, O-aryl-N-carbamato, N-alkyl-O-carbamato, N-aryl-β-carbamato, optionally alkyl or aryl-substituted P-phosphonato, optionally alkyl or aryl-substituted O-phosphonato, optionally alkyl or aryl-substituted P-phosphinato, optionally alkyl or aryl-substituted O-phosphinato, optionally alkyl or aryl-substituted phosphino, hydroxycarbonyl, alkoxycarbonyl, aryloxycarbonyl, cyclic or acyclic carbonate, and alkylcarbonato- or arylcarbonato substituents,
Q² stands for a hetero atom-containing divalent residue selected from the group consisting of —O—, —S—, —N(R¹¹)—, —C(O)—, —C(O)—O—, —O—C(O)—O—, epoxy, —O—C(O)—N(R¹¹)—, —N(R¹¹)—C(O)—O—, —S(O)—, —S(O)₂—, —S(O)—O—, —S(O)₂—O—, —O—S(O)₂—O—, —C(O)—N(R¹¹)—, —S(O)₂—N(R¹¹)—, —S(O)₂—N[C(O)R¹³]—, —O—S(O)₂—N(R¹¹)—, —N(R¹¹)—S(O)₂—O—, —P(O)(OR¹²)—O—, —O—P(O)(OR¹²)—, —O—P(O)(OR¹²)—O—, —P(O)(OR¹²)—N(R¹¹)—, —N(R¹¹)—P(O)(OR¹²)—, —O—P(O)(OR¹²)—N(R¹¹)—, —N(R¹¹)—P(O)(OR¹²)—O—, —N[C(O)R¹³]—, —N═C(R¹³)—O—, —C(═NR¹¹)—, —C(R¹³)═N—O—, —C(O)—N[C(O)R¹³]—, —N[S(O)₂R¹⁴]—, —C(O)—N[S(O)₂R¹⁴]—, —N[P(O)R¹⁵₂]—, —Si(R¹⁶₂)—, —[Si(R¹⁶₂)O]ₐ—, and —[OSi(R¹⁶₂)]ₐ— and —[OSi(R¹⁶₂)]ₐO—, wherein R¹¹, R¹² and R¹³ stand for hydrogen or optionally substituted C₁-C₂₀ alkyl or C₆-C₂₀ aryl residues, R¹⁴ stands for an optionally substituted C₁-C₂₀ alkyl or C₆-C₂₀ aryl residue, R¹⁵ stands for an optionally substituted C₁-C₂₀ alkyl, C₆-C₂₀ aryl, C₁-C₂₀ alkoxy or C₆-C₂₀ aryloxy residue, R¹⁶ stands for a C₁-C₂₀ alkyl, C₆-C₂₀ aryl, C₁-C₂₀ alkoxy or C₆-C₂₀ aryloxy residue and a stands for a number from 1 to 100,
Q³ stands for a hetero atom-containing trivalent residue, selected from the group consisting of —N═ and —P═,
X means a hydrolyzable group,
s has the values 1, 2 or 3,
v has the values 0 or 1,
w has the values 0 or 1, and
x has the values 0 or 1.

2. A process for Droducing the polymers (P) as claimed in claim 1, wherein at least one highly branched or hyper-branched polyolefin (HBPO) is grafted under radical conditions with one or more unsaturated compounds, at least one whereof is a silane or a silane precondensate, which (i) contains at least one unsaturated group sufficiently enabling for grafting and which (ii) bears at least one hydrolyzable group on at least one silicon atom.

3. The process as claimed in claim 2, wherein a highly branched or hyperbranched polyolefin HBPO of the general formula III is used,
R^{A}[(CH₂)(CHR^{a})]ₚ[(CH₂)ₖ(CR^{c}R^{d})]ₘR^{U}_{q}R^{O}ₜR^{B} (III),
wherein monomers of the structure H₂C═C(H)(R^{a}) were used for the production of the polymers of the formula III in at least one synthesis step,
monomers of the structure H₂C═C(R^{c})(R^{d}) were used for the production of the polymers of the formula III in no synthesis step,
the structure of the monomers H₂C═C(H)(R^{a}) is not identical with the structure of the monomers H₂C═C(R^{c})(R^{d}),
the relationship m=r′×(m+p+q+l t) applies and
r′ takes a value greater than or equal to 0.02.

4. The process as claimed in claim 2, wherein silanes of the general formula IV
R²¹₂C³═C⁴(R²²)—(R²³_{y}—C⁵(R²⁴₂))_{z}—R²⁵ᵤ—SiXₛR¹₃₋ₛ (IV),
are used, wherein
R²¹ and R²² mean hydrogen, fluorine, chlorine or a hydrocarbon residue which is unsubstituted or substituted by one or more monovalent substituents Q¹ or interrupted by one or more divalent groups Q² or interrupted by one or more trivalent groups Q³,
R²³ can take the same meanings as defined above for R², wherein, when y is not equal to 0, that atom in R²³ which is bound to the carbon atom C⁵ is a carbon atom,
R²⁴ can take the same meanings as defined above for R³, wherein that atom in R²⁴ which is bound to the carbon atom C⁵ is a carbon atom or a hydrogen atom,
R²⁵ can take the same meanings as R⁴ as defined above, wherein, when u is not equal to 0, that atom in R²⁵ which is bound to the unit —SiXₛR¹₃₋ₛ is an oxygen atom, and that atom in R²⁵ which is bound to the unit R²¹₂C³=C⁴(R²²)—(R²³_{y}—C⁵(R²⁴₂))_{z}— is a silicon atom,
u can take the same meanings as defined above for x,
y can take the same meanings as defined above for v,
z can take the same meanings as defined above for w,
wherein R¹, R²¹, R²², R²³, R²⁴, R²⁵, X, Q¹, Q² and Q³ can be bound to each other within the general formula IV, so that one or more rings are formed,
and wherein z=1, when that atom in R²² which is bound to the carbon atom C⁴ in the general formula IV is an atom other than a carbon atom or a hydrogen atom.

5. A process for producing the polymers (P) as claimed in claim 1, wherein at least one olefinically unsaturated monomer of the structure H₂C═CHR^{a} is copolymerized under radical conditions with at least one compound which has (i) at least one olefinically unsaturated C═C double bond and (ii) at least one silicon atom which bears at least one hydrolyzable group, and wherein the copolymerization is performed at temperatures of 150° C. to 360° C. and at pressures of 5 MPa to 500 MPa absolute.

6. The process as claimed in claim 5, wherein silanes of the general formula V
H₂C═C(R^{f})(R^{Si}) (V),
are used.

7. Binding agents which contain at least one of the polymers (P) as claimed in claim 1.

8. The binding agents as claimed in claim 7, which contain substances which are selected from the group consisting of adhesive resins, waxes, plasticizers, heat or light stabilizers, brighteners, antistatic agents, parting and antiblocking agents, adhesion promoters, organofunctionalized silanes, alkoxy-silanes, fillers and dyes, pigments, fire retardants, radical absorbers and antioxidants.

9. A method of using the polymers (P) as claimed in claim 1 alone or as a component of formulations as binding agents, as melt adhesives or as reactive melt adhesives, for producing adhesive joints, glued structures, coatings, paints, adhesive tapes, adhesive films, pressure-sensitive adhesives or foams.

10. A process for crosslinking of the polymers (P) as claimed in claim 1 or of mixtures containing at least one of the polymers (P), with water.

11. A crosslinked polymer (PV) which is obtainable by cross-linking of the polymers (P) as claimed in claim 1 with water or with oxide groups or hydroxyl groups other than water or SiOH.

12. Polymers (P) as claimed in claim 1, wherein R^{a} means hydrogen.

13. The process as claimed in claim 3, wherein silanes of the general formula IV
R²¹₂C³═C⁴(R²²)—(R²³_{y}C⁵(R²⁴₂))_{z}—R²⁵ᵤ—SiXₛR¹₃₋ₛ (IV),
are used, wherein
R²¹ and R²² mean hydrogen, fluorine, chlorine or a hydrocarbon residue which is unsubstituted or substituted by one or more monovalent substituents Q¹ or interrupted by one or more divalent groups Q² or interrupted by one or more trivalent groups Q³,
R²³ can take the same meanings as defined above for R², wherein, when y is not equal to 0, that atom in R²³ which is bound to the carbon atom C⁵ is a carbon atom,
R²⁴ can take the same meanings as defined above for R³, wherein that atom in R²⁴ which is bound to the carbon atom C⁵ is a carbon atom or a hydrogen atom,
R²⁵ can take the same meanings as R⁴ as defined above, wherein, when u is not equal to 0, that atom in R²⁵ which is bound to the unit —SiXₛR¹₃₋ₛ is an oxygen atom, and that atom in R²⁵ which is bound to the unit R²¹₂C³═C⁴(R²²)—(R²³_{y}—C⁵(R²⁴₂))_{z}— is a silicon atom,
u can take the same meanings as defined above for x,
y can take the same meanings as defined above for v,
z can take the same meanings as defined above for w,
wherein R¹, R²¹, R²², R²³, R²⁴, R²⁵, Q¹, Q² and Q³ can be bound to each other within the general formula IV, so that one or more rings are formed, and wherein z=1, when that atom in R²² which is bound to the carbon atom C⁴ in the general formula IV is an atom other than a carbon atom or a hydrogen atom.
